(19) United States
(12) Patent Application Publication
(10) Pub. No.: US 2011/0164110 A1
(43) Pub. Date: Jul. 7, 2011

(54) METHOD AND SYSTEM FOR DETECTING COMPRESSED STEREOSCOPIC FRAMES IN A DIGITAL VIDEO SIGNAL

(75) Inventors: Etienne FORTIN, Saint-Bruno-De-Montarville (CA); Nicholas ROUTHIER, Candiac (CA); Daniel MALOUIN, St-Basile-le-Grand (CA)

(73) Assignee: SENSIO TECHNOLOGIES INC., Montreal (CA)

(21) Appl. No.: 12/977,577

(22) Filed: Dec. 23, 2010

Related U.S. Application Data
(60) Provisional application No. 61/291,910, filed on Jan. 3, 2010.

(51) Int. Cl. H04N 13/00

(52) U.S. Cl. 348/43; 348/E13.062

(57) ABSTRACT

Detection compressed stereoscopic frames in a digital video stream. A stereoscopy detector is capable of detecting whether an image stream is stereoscopic or not, where the image stream may be monoscopic, stereoscopic and, in the latter case, encoded in one of many different possible stereoscopic encoding formats. The stereoscopy detector may also detect a particular encoding format for a stereoscopic image stream. The stereoscopy detector may also detect if quincunx encoding was used. Stereoscopy may be detected based on an observation of two portions in a frame sequence, and based on a comparison of segments in each portion. A change between stereoscopy and monoscopy, or between stereoscopic formats, may be detected as well, and may be detected based on multiple tests in time in a deliberate hysteresis.

### CROSS-REFERENCE TO RELATED APPLICATION

The present application claims the benefit of U.S. provisional application Ser. No. 61/291,910, filed Jan. 3, 2010, the specification of which is hereby incorporated by reference.

### TECHNICAL FIELD

This invention relates generally to the field of digital signal processing and more specifically to the detection of stereoscopy in a digital video signal.

### BACKGROUND

Various different types of digital broadcasting services exist and are available to users, including the more common interlaced and non-interlaced broadcasting services, as well as the less conventional stereoscopic broadcasting service. In the case of the more common broadcasting services, the video signal as captured and transmitted is characterized by a particular digital format, defined for example by a specific resolution, scanning method and frame rate. For example, the broadcasted video signal may be 720p60 video material, 1080i60 video material or 1080p60 video material, among many other possibilities. In the case of the stereoscopic broadcasting service, two video signals or image sequence signals may be encoded into a single video signal for transmission, where decoding of this single video signal allows reproduction of a three-dimensional stereoscopic program in multiple viewing formats.

When broadcasting or transmitting any type of digital video signals, some form of compression or encoding is often applied to the video signals in order to reduce data storage volume and bandwidth requirements. For instance, it is known to use a quincunx or checkerboard pixel decimation pattern in video compression. Obviously, such techniques lead to a necessary recovery operation at the receiving end, in order to retrieve the original image streams.

Commonly assigned U.S. Pat. No. 7,580,463, describes stereoscopic image pairs of a stereoscopic video are compressed by removing pixels in a checkerboard pattern and then collapsing the checkerboard pattern of pixels horizontally. The two horizontally collapsed images are placed in a side-by-side arrangement within a single standard image frame, which may then be subjected to conventional image compression (e.g. MPEG2 or MPEG4) before being transmitted by, for example, a stereoscopic broadcasting system. At the receiving end, each standard image frame undergoes conventional image decompression, after which the decompressed standard image frame is further decoded, whereby it is expanded into the checkerboard pattern and the missing pixels are spatially interpolated for each one of the pair of images.

One difficulty that exists at the receiving end of a video signal transmission, for example in a digital broadcast receiver or a component of a multimedia system (e.g. a server or a set-top box (STB)), is the ability to distinguish between the different types of incoming video signals, including between a regular image sequence (e.g. a sequence of 2D image frames) and a stereoscopic image sequence (e.g. a stream of image frames, each frame consisting of two images compressed and arranged in a side-by-side format) or between different types of stereoscopic image sequences. This ability is an important and desirable one since depending on the type of data received the frames of a received video stream (e.g. after undergoing conventional image decompression such as MPEG2 or MPEG4 decompression) may need to be further decoded; however this decoding process is dependent on the particular type of frame that has been received.

Unfortunately, digital broadcast receivers are not typically designed to handle both the stereoscopic broadcasting service and the conventional interlaced or non-interlaced broadcasting service, but rather are intended for use in receiving one or the other specific type of broadcasting service. A broadcast receiver with the dual functionality would require two separate tuners, one dedicated specifically to the stereoscopic broadcasting service, thus requiring burdensome and expensive circuitry.

Enabling the distinction between different types of broadcasting services at the receiving end typically requires the generation and transmission to the receiving end of a separate control signal indicative of the type of broadcasting service in use. This separate control signal may be independent of the actual digital video signal being broadcast, sent in parallel to or in advance of the transmitted video stream. Alternatively, the control signal may be embedded or encoded in the actual video stream prior to transmission. Clearly, these prior art methods are active ones, in that they require the implementation of additional operations at the transmitting end, be it generation of a separate control signal or manipulation of the video stream to be transmitted, in order to allow the receiving end to distinguish between different types of broadcast services.

European Patent Application No. EP 1024672 A1, published Aug. 2, 2000 in the name of Sanyo Electric Co., Ltd., discloses a digital broadcast receiver and a display apparatus capable of reception and display of a plurality of broadcasting methods including a stereoscopic broadcasting method. For each received frame of an incoming digital video signal, a determining circuit in the receiver compares the pixel data from two specific areas of the respective frame and, based on the results of the comparison, determines whether the received video data is in accordance with the stereoscopic broadcasting method. An output signal formatting circuit generates an output signal for displaying a video image on a monitor based on this determination. The locations of the two specific areas within the frame are such that, in the case of a non-stereoscopic signal, the pixel data of the two areas would normally have a low correlation. However, in the case of a stereoscopic signal, one of the specific areas would contain pixel data based on a right eye video signal, while the other one would contain pixel data based on a left eye video signal, and a comparison of the two areas would normally reveal a high correlation between the pixel data. The determination of low or high correlation can be done by different methods, one example being a measure of the colour difference between the pixel data of the two specific areas. However, the methods described in this application have been found to be inadequate. In particular, it only functions with one type of stereoscopic encoding format and cannot be used if the incoming digital video signal is in another format. Furthermore the comparison performed requires knowledge of areas where a high correlation is expected if stereoscopic and low correlation is expected if non stereoscopic. This is not information that is usually available, particularly if there are multiple different stereoscopic formats possible for the incoming digital video signal. Moreover, the actual detection method described has been found to be inadequate. By looking at a two single continuous block of pixels and performing a single act of comparison based thereon, a high error rate may result.

Japanese Patent Application Publication No. JP03295393A2, published Dec. 26, 1991 in the name of Hitachi Ltd. et at, appears to describe a method of automatically discriminating stereoscopy by detecting some difference in a signal between a reference screen and an odd-number screen and an even-number screen. In particular, one of every three fields is stored and is set as a reference screen. The correlation between the reference screen and an odd number screen is then compared to the correlation between the reference screen and an even number screen and based on this, stereoscopy discriminated. This method is believed to be only useful for a very specific type of stereoscopy and cannot work if a different type or multiple types of stereoscopy is used. Furthermore, by requiring the comparison an even and odd frames with a reference frame, this method requires three instance of comparison, resulting in relatively high computational requirements, and longer time requirements. Finally, this method is expected to produce lots of errors, since the correlation between odd and even frames with a reference frames is expected to vary with movement and scene changes in a video.

Consequently, there exists a need in the industry to provide a useful manner of detecting stereoscopy.

### SUMMARY

In accordance with a non-limiting embodiment is provided a method of detecting stereoscopy in a digital image stream comprising a frame sequence. The method comprises receiving at an input the frame sequence. The method further comprises detecting whether the frame sequence is in one of a plurality of stereoscopic encoding format. The method further comprises outputting at an output an indication of the result of the detecting.

In accordance with another non-limiting embodiment is provided a system for detecting stereoscopy. The system comprises an input for receiving a frame sequence. The system further comprises a stereoscopy detector for in communication with the input configured to detect on the basis of at least a portion of the frame sequence whether the frame sequence is in one of a plurality of stereoscopic encoding format. The system further comprises an output in communication with the stereoscopy detector for outputting an indication of the result of the detecting.

In accordance with another non-limiting embodiment, is provided an image processing apparatus in connection with a display device. The image processing apparatus is configured to receive an image stream in a particular mode from among a plurality of modes, the plurality of modes comprising a monoscopic mode and a plurality of stereoscopic modes. The image processing apparatus is further configured to detect the particular mode. The image processing apparatus is further configured to cause the display device to display the image stream either monoscopically or stereoscopically at least in part on the basis of the mode detected.

### BRIEF DESCRIPTION OF THE DRAWINGS

The invention will be better understood by way of the following detailed description of embodiments of the invention with reference to the appended drawings, in which:

FIG. 1 is a schematic representation of a system for generating and transmitting a stereoscopic image stream;

FIG. 2A is an example of a pair of original image frames of a high definition video stream;

FIGS. 2B and 2C illustrate quincunx sampling, horizontal collapsing and merging together of the two frames of FIG. 2A into a merged stereoscopic frame;

FIG. 3 is an example of the a merged stereoscopic frame;

FIG. 4 illustrates the first four frames of a stereoscopic dual frame sequence and a stereoscopic true side-by-side merged frame sequence derived therefrom;

FIG. 5A illustrates the first four frames of a stereoscopic dual frame sequence and a stereoscopic non-true side-by-side merged frame sequence derived therefrom;

FIG. 5B illustrates the first four frames of a stereoscopic dual frame sequence and another stereoscopic non-true side-by-side merged frame sequence derived therefrom;

FIG. 6 illustrates the generation of an above-below merged frame from a left and right frame;

FIG. 7 is an example of a line-interleaved merged frame;

FIG. 8 is an example of a column-interleaved merged frame;

FIG. 9 illustrates the first four frames of a stereoscopic dual frame sequence and a stereoscopic frame sequential frame sequence derived therefrom;

FIG. 10 is a block diagram of an image processing architecture according to a non-limiting example;

FIG. 11A is a block diagram of a stereoscopy module according to a non-limiting example;

FIG. 11B is a block diagram of a stereoscopy module according to another non-limiting example;

FIG. 12 is a flow diagram of a process implemented by a stereoscopy detector, according to a non-limiting example;

FIG. 13 is an example of a side-by-side merged frame;

FIG. 14 illustrates a stereoscopy module implementing quincunx detection according to a non-limiting example;

FIG. 15A is an example of a left image in a stereoscopic dual image stream;

FIG. 15B illustrates a frequency domain representation of side-by-side merged frame;

FIG. 15C illustrates a frequency domain representation of side-by-side quincunx merged frame;

FIG. 16 illustrates a frame undergoing quincunx detection; and

FIG. 17 is a block diagram of an image processing architecture according to another non-limiting example.

### DETAILED DESCRIPTION

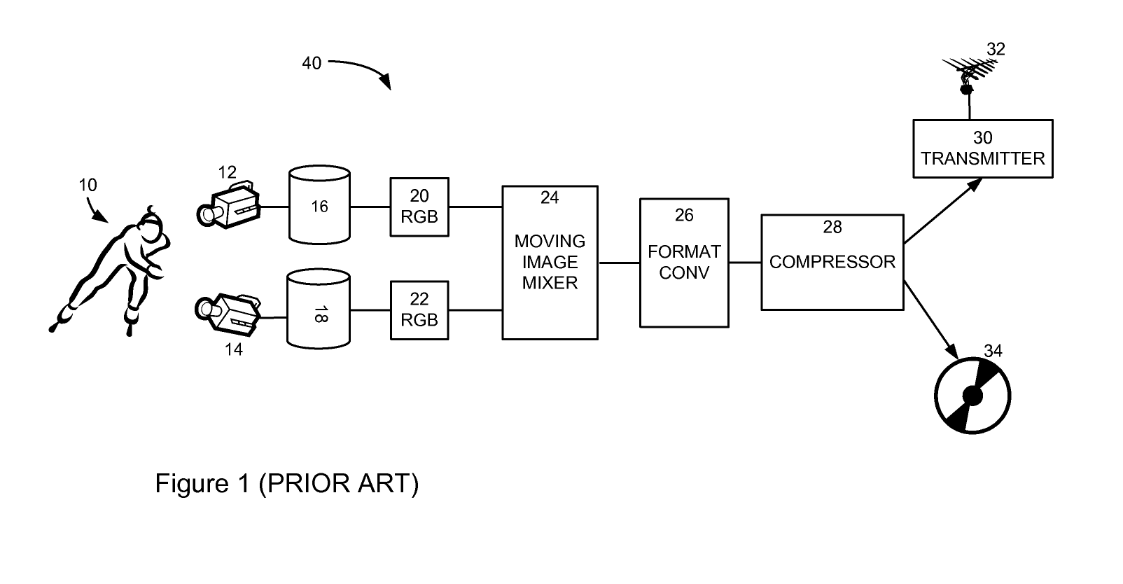

FIG. 1 illustrates an example of a system 40 for generating and transmitting a stereoscopic image stream. A first and a second source of image streams are represented by cameras 12 and 14. Alternatively, image streams may be provided from digitized movie films or any other source of digital picture files stored in a digital data storage medium or inputted in real time as a digital video signal suitable for reading by a microprocessor based system. Cameras 12 and 14 each generate respective image streams. An image stream is a representation of video in the form of a plurality of still images and can be implemented in a digital form for example as digital stored data or as a digital communication signal. In this case, each camera 12, 14 generates an image stream in the form of a frame sequence, that is, a sequence of frames. In a frame sequence the frames define the image data of the image sequence. The frames in a frame sequence may each define an entire image, as is the case for example in a progressive feed or only a part of an image, such as a field. Thus a frame can comprise only a single field of a two-field set.

Cameras 12 and 14 are shown in a position wherein their respective captured image sequences represent different views with a parallax of a scene 10, simulating the perception of a left eye and a right eye of a viewer, according to the concept of stereoscopy. The two cameras therefore generate two image streams, on for each of the left eye perspective and right eye perspective. These left and right image streams may take the form of digital frame sequences: a left frame sequence defining images corresponding to a left eye perspective and a right frame sequence defining images corresponding to a right eye perspective. The frames of a left frame sequence and frames of the right frame sequence may be referred to as left frames and right frames, respectively. The stereoscopic image stream may be transmitted as a stereoscopic dual frame sequence, whereby the two frame sequences are transmitted on separate channels. Alternatively, it is also possible to encode the left and right frame sequence on a single frame sequence, that is, a frame sequence that can be transmitted on a single channel. Encoding a stereoscopic image stream as a single frame sequence may permit distribution or storage of the stereoscopic image stream using legacy media not adapted for stereoscopic dual frame sequences, or may simply permit (depending on the encoding format used) the reduction of the bandwidth or space required for the stereoscopic image stream.

Each of the single frame sequences that make up the stereoscopic dual frame sequence can be stored in an appropriate storage medium, which in this example is provided in the form of two storage devices 16, 18, but could be a single same storage device as well. If color space conversion, e.g. from YUV or YCbCr to RGB or vice versa is desired, this may be done by the illustrated color processors 20 and 22. The stereoscopic dual image stream is then fed to inputs of moving image mixer 24. In this example, it is desired to provide the stereoscopic dual image stream in a single frame sequence. This is done by merging the left and right frame sequences of the stereoscopic dual frame sequence into a single frame sequence, called a stereoscopic single frame sequence. Traditional 2D monoscopic video, generally takes the form of a single frame sequence. It may be desirable for a stereoscopic single frame sequence to have a format typically used for 2D monoscopic single frame sequences to allow the stereoscopic single frame sequence to be processed by methods and equipment adapted to process traditional 2D monoscopic image streams. Thus, by encoding a stereoscopic dual frame sequence into a stereoscopic single frame sequence, it may be possible to store or transmit the stereoscopic video of the stereoscopic dual frame sequence as a single frame sequence using equipment methods and formats intended for monoscopic single frame sequences. There are several possible ways of encoding a stereoscopic dual frame sequence into a stereoscopic single frame sequence according to different encoding schemes which will be described in more detail further below.

Thus, the mixer 24 compresses or encodes the left and right frame sequences of the stereoscopic dual frame sequence into a stereoscopic single frame sequence, which may then undergo another format conversion by a processor 26 (for example a color space conversion). Before storage or transmission, the stereoscopic single frame sequence may also be compressed using a compression scheme such as the MPEG2, MPEG4, H.263 or other compression standard. As will be seen below, certain encoding schemes for encoding stereoscopic dual frame sequences into a stereoscopic single frame sequences result in a single frame sequences that lend themselves well to standard encoding. In the present example, the stereoscopic single frame sequence is compressed into a compressed stereoscopic single frame sequence using, in this example, MPEG2 compression. The resulting MPEG2 coded bitstream can then be broadcasted on a single standard channel through, for example, transmitter 30 and antenna 32 or recorded on a conventional medium such as a DVD. Alternative transmission medium could be, for instance, a cable distribution network or the Internet.

It will be appreciated that compression is strictly optional and that a frame sequence can be stored or communicated without first being compressed.

Returning now to the manner in which a stereoscopic dual frame sequence is encoded into a stereoscopic single frame sequence, several encoding schemes may be used to provide a stereoscopic single frame sequence in different encoding formats. For many reasons, it may be desired to encode a stereoscopic dual frame sequence as a single frame sequence. For example, it may be desired to transmit a stereoscopic video over an infrastructure (e.g. legacy cable or satellite distribution networks) that is not suited for transporting dual frame sequences. Alternatively it may be desired to store a stereoscopic video on media not suited for transporting dual frame sequences. Alternatively still it may simply be desired to reduce the space or bandwidth required by a stereoscopic dual frame sequence. Whatever the reason, several encoding schemes exist to encode a stereoscopic dual frame sequence as a stereoscopic frame sequence. In many cases, some loss may occur the overall amount of information in the stereoscopic dual image stream may be reduced to fit into a stereoscopic single frame sequence.

A first class of stereoscopic single frame sequence encoding formats includes the merged-frame formats. In a merged-frame format, two or more frames from a stereoscopic dual frame sequence are in whole or in part merged into single frames to form a stereoscopic single frame sequence. In stereoscopic merged frame sequences, the frames comprise two or more subframes, each subframe being derived from a respective (left or right) frame from a stereoscopic dual frame sequence. A first example of a merged frame encoding will now be described.

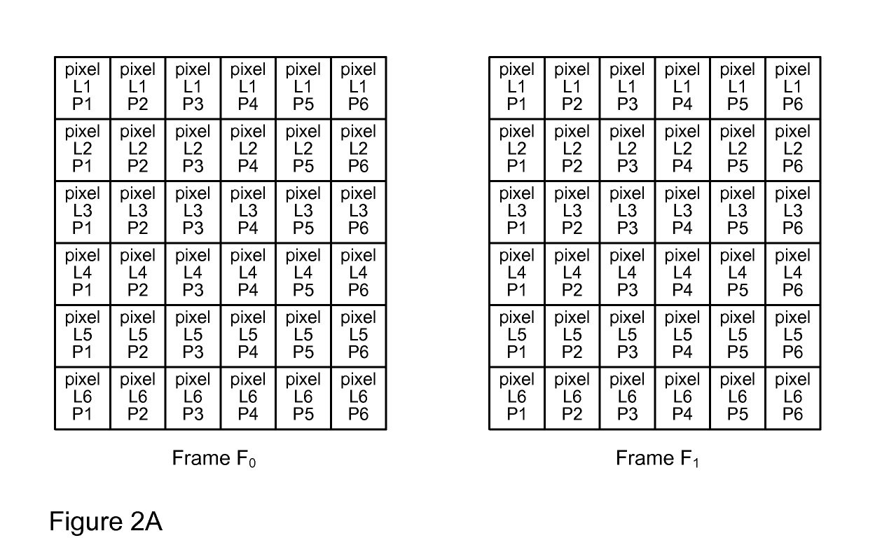

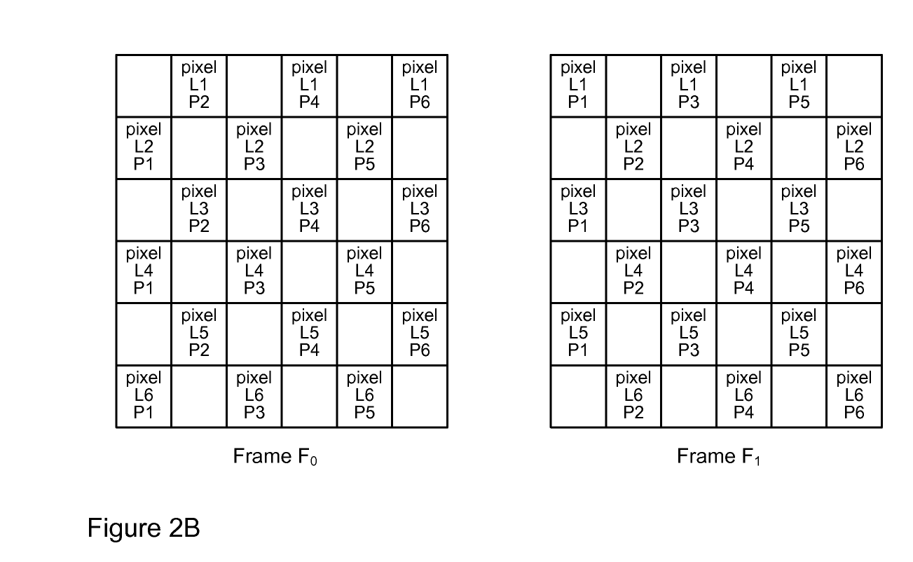

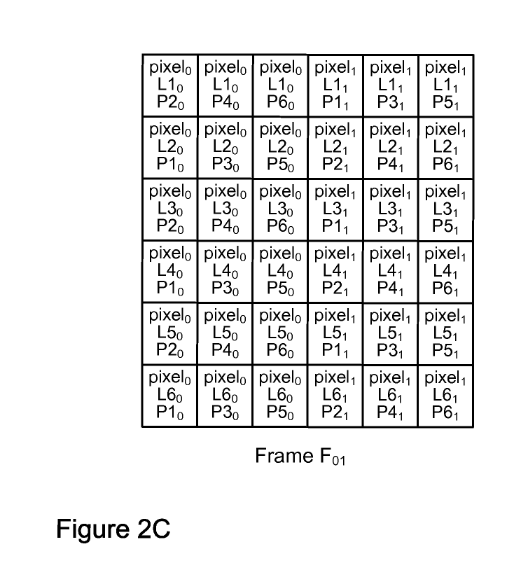

FIG. 2A illustrates a non-limiting example of a pair of frames F₀ and F₁ belonging to left and right frame sequences respectively. Frames F₀ and F₁ represent images that were captured and prepared for transmission by a system 40 such as that shown in FIG. 1. In this example, image frames F₀ and F₁ represent simultaneous left eye and right eye perspectives, as captured by cameras 12 and 14 and can be considered left and right frames respectively. For the purpose of this illustration, the frames F₀ and F₁ are shown here as having only 36 pixels each, although it will be appreciated that these frames may, and typically would, have many more pixels. In FIG. 2A, these pixels are original pixels arranged in rows and columns, before any sampling has been performed. With regard to the pixel identification, L designates the vertical position of a pixel in terms of line number and P designates the horizontal position of a pixel in terms of pixel number/line. In this example, the moving image mixer 24 is operative to perform a decimation process on each one of frames F₀ and F₁, in order to reduce the amount of information contained in each respective frame.

In this non-limiting example, the moving image mixer 24 samples each received frame in a quincunx pattern. Quincunx sampling is a sampling method by which sampling of odd pixels (and discarding of even pixels) alternates with sampling of even pixels (and discarding of odd pixels) for consecutive rows, such that the sampled pixels form a checkerboard pattern. FIG. 2B illustrates a non-limiting example of sampled frames F₀ and F₁, where the moving image mixer 24 has decimated frame F₀ by sampling the even-numbered pixels from the odd-numbered lines of the frame (e.g. sampling pixels P2, P4 and P6 from line L1) and the odd-numbered pixels from the even-numbered lines of the frame (e.g. sampling pixels P1, P3 and P5 from line L2). In contrast, the moving image mixer 24 has decimated frame F₁ by sampling the odd-numbered pixels from the odd-numbered lines of the frame (e.g. pixels P1, P3 and P5 from line L1) and the even-numbered pixels from the even-numbered lines of the frame (e.g. pixels P2, P4 and P6 from line L2). Thus, both frames F₀ and F₁ are quincunx-decimated frames. In this example, they have been decimated according to a complementary quincunx pattern (relative to one another). Two decimation patterns may be said to be complementary to one another when the pixels remaining according to a first decimation pattern fit within the holes created by the second decimation pattern. In this example, the frame F₀ and the frame F₁ are decimated according to complementary decimation patterns. This may be referred to as complementary quincunx decimation. Alternatively, both frames F₀, F₁ may be identically sampled according to the same quincunx sampling pattern.

In certain embodiments, the moving image mixer 24 may apply complementary sampling in a time-sequential manner such that frames F₀ and F₁ are sampled in a manner that is complementary to the frames immediately preceding and following them (as well as, optionally, each other as shown).

Once the frames F₀, F₁ have been sampled, they are collapsed horizontally and placed side by side within new merged frame F₀₁, as shown in FIG. 2C. Thus, each one of frames F₀ and F₁ is spatially compressed by 50% by discarding half of the pixels of the respective frame, after which compression the two sampled frames are merged together to create a new image frame F₀₁. The portions of new merged frame F₀₁ comprising information previously contained in frames F₀ and F₁ are called subframes. F₀₁ has two subframes.

This encoding format of frames F₀ and F₁ within new image frame F₀₁ is mostly transparent and unaffected by further compression/decompression that may occur downstream in the process, regardless of which scanning system (progressive or interlaced) is used.

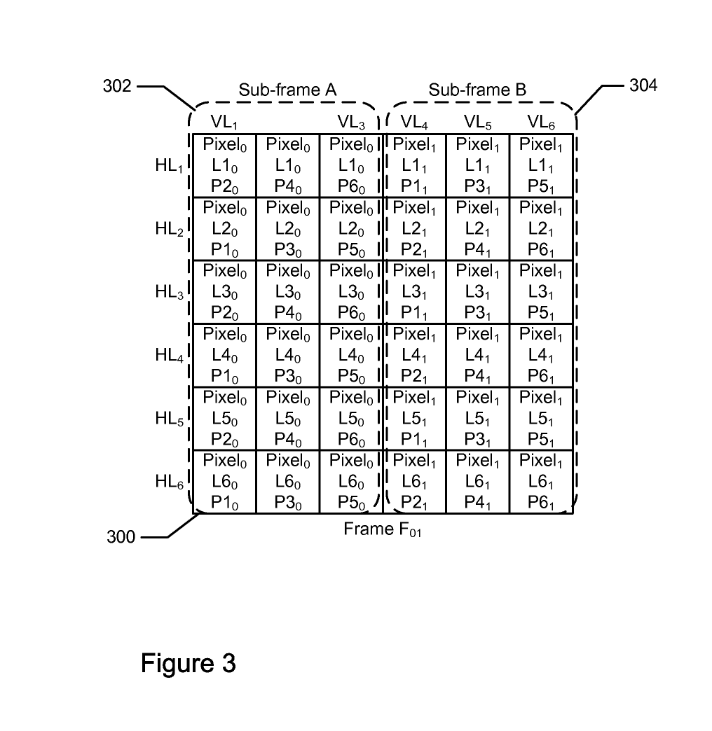

FIG. 3 illustrates a non-limiting example of a pictorial representation of frame F₀₁ as output by system 40 in a stereoscopic video signal. This frame may be said to have undergone encoding according to a quincunx decimation side-by-side scheme such as to form a quincunx side-by-side merged frame.

The above example shows only one of many types of side-by-side encoding. Side-by-side encoding, generally refers to types of encoding where two portions of a stereoscopic dual frame sequence are placed side-by-side in the frames of a stereoscopic single frame sequence. Most commonly, as in the example above, frames from the stereoscopic dual frame sequence are reduced in size by at least 50% width wise and placed side by side (concatenated) such as to form a frame of the stereoscopic merged frame sequence. It is to be understood that the reduction may be greater than 50%, particularly if it is desired to introduce a gap between the two ensuing subframes.

In the above example the described merged frame comprised a subframe formed from a left frame (from a left frame sequence in a stereoscopic dual frame sequence) and a subframe formed from a corresponding right frame (from a corresponding right frame sequence). When the merged frames of a merged frame sequence each contain a left subframe, from a left frame and a right subframe from a corresponding right frame, this may be called true side-by-side. It should be noted that left and right frames of a stereoscopic frame sequence are considered to be corresponding to one another when they are chronologically related, by being simultaneous views (if simultaneous left and right frame are available, e.g. if the capture system provide simultaneous left and right frame capture) or nearly simultaneous sequential views (e.g. if the capture system can only provide sequential left and right frame views).

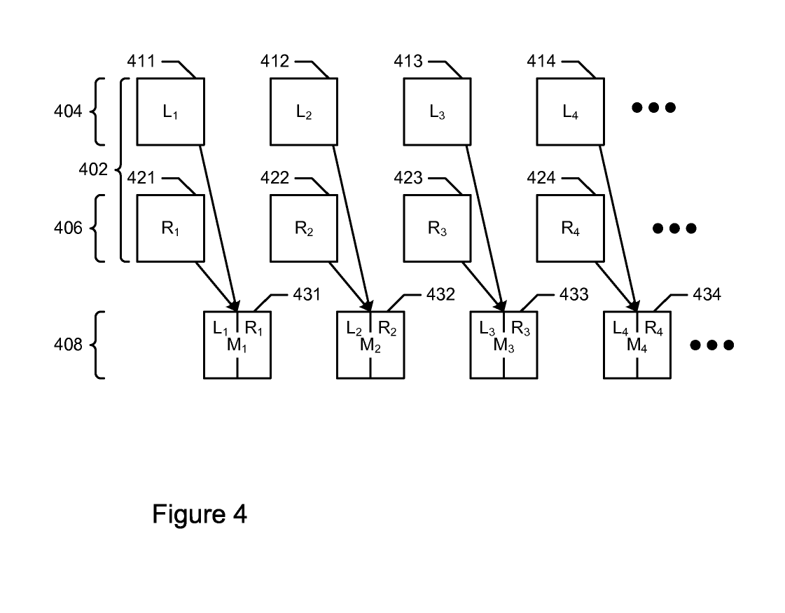

True side-by-side is illustrated in FIG. 4, where a stereoscopic dual frame sequence 402 is shown as comprising a left frame sequence 404 of left frames 411 . . . 414 and a right frame sequence 406 comprising right frame sequence 406 of corresponding right frames 421 . . . 424. Merged frame sequence 408 is a true side-by-side frame sequence because each of the merged frames 431 . . . 434 have two subframes arranged side by side and derived from corresponding left frames and right frames from the stereoscopic dual frame sequence 402.

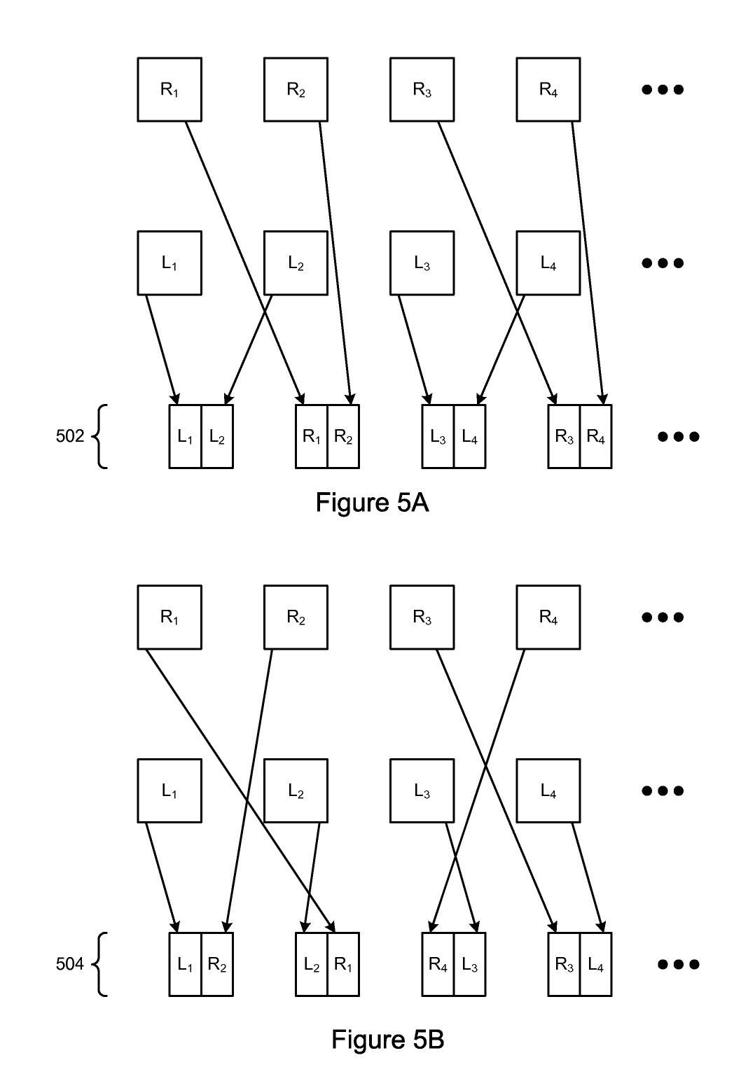

Generally, all merged frame formats having two subframes, one being made up of a left frame and another being made up of a corresponding right frame will be referred to as “true”. It is to be understood that non-true merged frame formats may also be used to encode a stereoscopic dual frame sequence as a stereoscopic single frame sequence. Examples of non-true side-by-side merged frames sequences are shown in FIG. 5A, where merged frame sequence 502 comprises merged frames having subframes derived from either two left frames or two right frames, and FIG. 5B where merged frame sequence 404 comprises merged frames having subframes made up of non-corresponding left and right frames.

Returning to the example of FIGS. 2A-2C, the particular variety of side-by-side merged frame format described above is called a quincunx side-by-side merged frame format because the reduction of the left and right frames used quincunx decimation (or sampling). The resulting stereoscopic single frame sequence may be called a quincunx side-by-side merged frame sequence.

Besides quincunx side-by-side other manners of arranging subframes in a side-by-side manner may be used. In one example of non-quincunx side-by-side, called scaled side-by-side, two frames from a stereoscopic dual frame sequence are scaled down in width by at least 50% using an appropriate scaling technique such as any suitable scaling algorithm, e.g. bicubic algorithm. In yet another example of non-quincunx side-by side called side by side column subsampling, two frames from a stereoscopic dual frame sequence have at least half of their columns of pixels (generally single-pixel in width but could be larger) decimated (e.g. every second column). The remaining columns of pixels are then squeezed together to make subframes of a side-by-side merged frame. Generally any appropriate method may be used to generate side-by-side subframes in a side-by-side merged frame format.

For simplicity, in a merged frame comprising a subframe from a left frame and a subframe from a right frame, the subframe from the left frame will be referred to as the left subframe and the subframe from the right frame will be referred to as the right subframe, regardless of where in the merged frame these subframe are actually located. It should be noted that even in a side-by-side embodiment, left and right subframes need not necessarily be placed in the left and right side, respectively, of a merged frame.

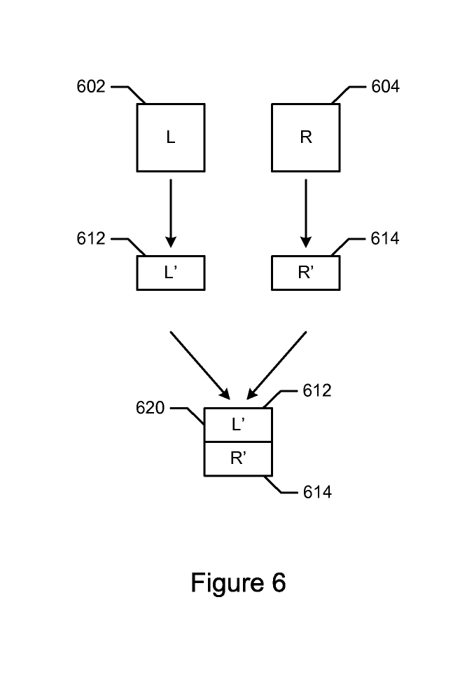

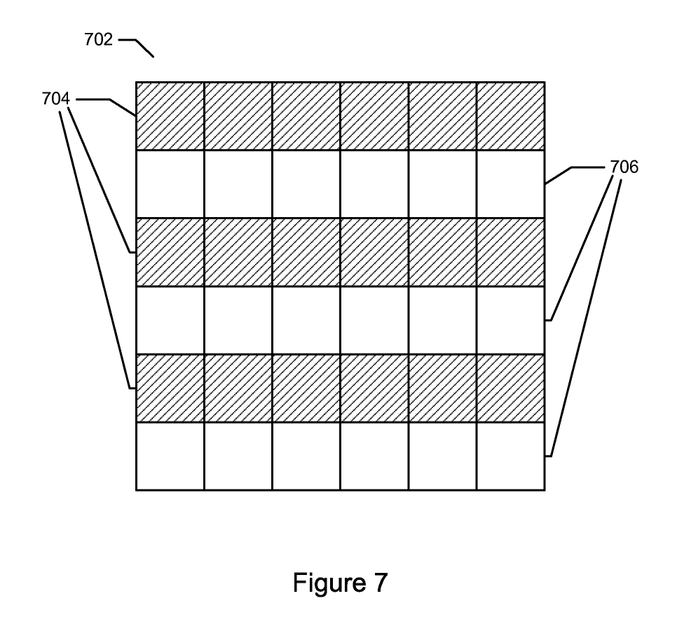

Besides side-by-side formats, other merged frame formats may be used. In the above-below format, frames of a stereoscopic dual frame sequence are reduced in size by at least 50% height-wise and placed in an above-below relationship in a merged frame. FIG. 6 shows an example of above-below encoding. Here a left frame 602 and a right frame 604 are reduced to half of their height to form left and right subframes 612 and 614 from which is generated a single merged frame 620 having the left subframe 612 above the right subframe 614. (In alternate embodiments, the position of the left and right subframes within merged frame 620 could be inversed.)

Any appropriate manner of reducing the left and right subframes height-wise may be used. For example, they may be scaled down in height using an appropriate scalar, or line-decimated in a manner similar to the column decimation described above, but by horizontal lines instead of columns.

It is to be understood that like in the side-by-side encoding formats described above, above-below formats may be true encoding formats, whereby each subframe is formed from corresponding left and right subframes, or any manner of non-true format.

In yet another merged frame format, called line-interleave, the subframes of a merged frame may be discontinuous height-wise. Shows an example of a merged frame 702 in a line-interleave merge frame format. The merged frame 702 comprises two subframes, a left subframe 704 being formed from a left frame of a stereoscopic dual frame sequence and a right subframe 706 being formed from a right subframe of a stereoscopic dual frame format. As shown, the left and right subframes 704 and 706 are discontinuous being composed of discrete lines of pixels. Here each line of pixel has a single-pixel in height, although thicker lines may be used as well.

Each subframe 704, 706 has been generated from a frame of a stereoscopic dual frame sequence in any suitable manner. In a simple example, the merged frame 702 may have the same dimensions as the left and right frames from which the subframes 704, 706 are created, and each line of the subframes 704, 706 are simply copies of the lines at the same location of their respective left and right frames from which they are made. This essentially means that the left and right frames are line-decimated (but not squeezed) to form the left and right subframes 702, 704. Alternatively, however, other means of generating the subframes 702, 704 may be used. For example, left and right frames could be scaled vertically down by 50% using a scalar have the resulting lines interleaved to obtain a line-interleave subframe 702 as shown.

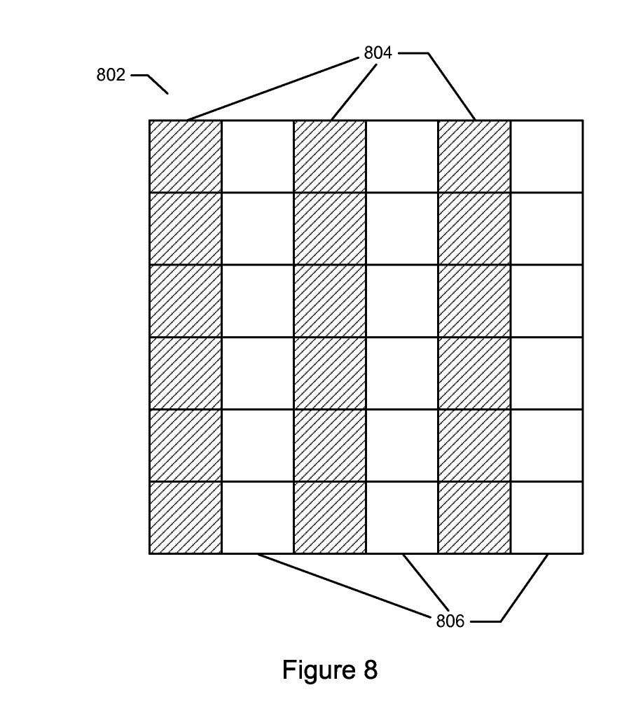

FIG. 8 shows yet another example of merged frame in a column-interleave format. Here left and right subframes 804, 806 are discontinuous in the width direction, being made up of discrete columns. These columns are single pixel in width but could be wider.

Each subframe 804, 806 has been generated from a frame of a stereoscopic dual frame sequence in any suitable manner. In a simple example, the merged frame 802 may have the same dimensions as the left and right frames from which the subframes 804, 806 are created, and each column of the subframes 804, 806 are simply copies of the columns at the same location of their respective left and right frames from which they are made. This essentially means that the left and right frames are column-decimated (but not squeezed) to form the left and right subframes 802, 804. Alternatively, however, other means of generating the subframes 802, 804 may be used. For example, left and right frames could be scaled horizontally down by 50% using a scalar have the resulting lines interleaved to obtain a line-interleave subframe 702 as shown.

It is to be understood that like in the side-by-side encoding formats described above, the line-interleave and column-interleave formats may be true encoding formats, whereby each subframe is formed from corresponding left and right subframes, or any manner of non-true format.

Other merged-frame encoding formats include tile formats, whereby a merged frame is separated into a number of tiles (e.g. four rectangles). In a tile format, subframes may consist of a single tile or plural tiles. For instance, using the four-rectangle example, each tile may represent a single frame of a stereoscopic dual frame sequence, for a total of four subframes. (This requires each encoded frame of the stereoscopic dual frame sequence be reduced to a quarter of its size, if the merged frame has the same size as the frames of the stereoscopic dual frame sequence.) Alternatively, still using the four-rectangle example, the top left and bottom right rectangles may be derived from a single (e.g. left) frame of the stereoscopic dual frame sequence to form a single discontinuous subframe, while the top right and bottom left rectangles may be derived from another (e.g. corresponding right) frame of the stereoscopic dual frame sequence to form another single discontinuous subframe.

Moreover, it should be noted that the subframes in a merged frame format need not have similar shape. For example in L-shaped encoding, a merged frame comprises two subframes, which may have the overall same dimensions (though not necessarily so, depending on the particular parameters desired for the L-shaped encoding) but different shapes. A first subframe is rectangular shaped and is located in the corner of the merged frame, while the other subframe forms an L-shape around it. Any other manner of subframe dimensioning may be used.

It is to be understood that the relative size, or the amount of data used by left and right subframes, need not be equal. Furthermore, the left and right frames from which a merged frame is made need not have the same dimensions as the merged frames. For example they may be scaled prior to or during the merging, or the merged frame may be scaled after creation.

Furthermore still, it is to be understood that a merged frame sequence need not have only merged frames. For example, it may be desired to transmit entire left or right frames at a certain interval, for example for the purposes of allowing testing the quality of the decoder, or to provide higher fidelity for left or right eye. If a particular merged frame format calls for occasional non-merged frames in the frame sequence, it is to be understood that the techniques described herein, including for stereoscopy detection, detection of a change between stereoscopy and non-stereoscopy and decoding may take into account knowledge of the presence and location of non-merged frames.

Moreover, merged frames may be created with only a portion of original left and right frames. For example, if the left and right frames are entire images and comprise two fields, it may be desired to drop one of the two fields and make a merged frame from only one of the fields of left and right frames.

It is also to be understood that while in the example above, the merged frames have comprised two subframes each, they could have more subframes, each being derived from a different frame of a stereoscopic dual frame sequence, or even only one subframe (that is, be derived entirely from a single frame of the stereoscopic dual frame sequence, e.g. as a replication thereof). Moreover, although the merged frames of the examples above have comprised subframes of corresponding left and right frames, merged frames may comprise subframes derived from any frames of a stereoscopic dual frame sequence. Thus a merged frame may comprise subframes derived from left frames only, or from right frames only, or from left and right frames that do not correspond to each other (e.g. chronologically separated).

Several merged-frame formats have been described hereabove, however it is to be understood that any other suitable manner of generating merged frame may be used.

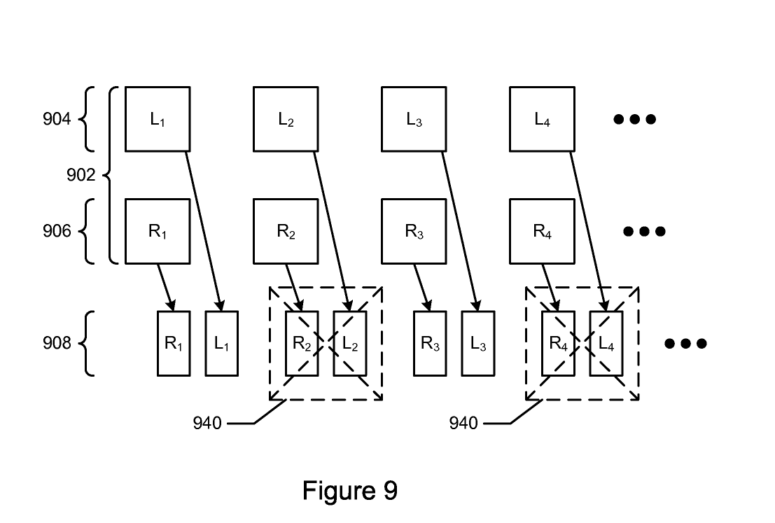

In addition to merged frame formats, other manners of encoding a stereoscopic dual frame format into a stereoscopic single frame format may be used. For example, in a frame sequential encoding format, frames of a stereoscopic dual frame sequence alternate in a single sequence. FIG. 9 illustrates and example of a frame sequential frame sequence. In a simple form of frame sequential encoding, the left frames of a left frame sequence 904 of a stereoscopic dual frame sequence 902 and the right frames of the corresponding right frame sequence 906 are alternated in a frame sequence 908. Thus the frames of the frame sequential frame sequence 908 are derived from left and right frames by virtue of being exact copies thereof. However, this encoding (for the purpose of this description, the frame sequential format is considered to be an encoding format) will result in a doubling of the number of frames for the frame sequence 908 and a doubling of the bandwidth required for the frame sequence 908. Alternatively, it is possible to reduce the number of frames, for example by dropping every second left and right frames, as illustrated by cross-outs 940. The dropped frames are then time-interpolated at the receiving end. Alternatively, other methods of reducing the bandwidth of a single frame sequence 908 may involve reducing the amount of data used to define each frame. Finally, although the frame sequence 908 is shown here as having a regular alternation of left and right frames, it is to be understood that other orderings are possible.

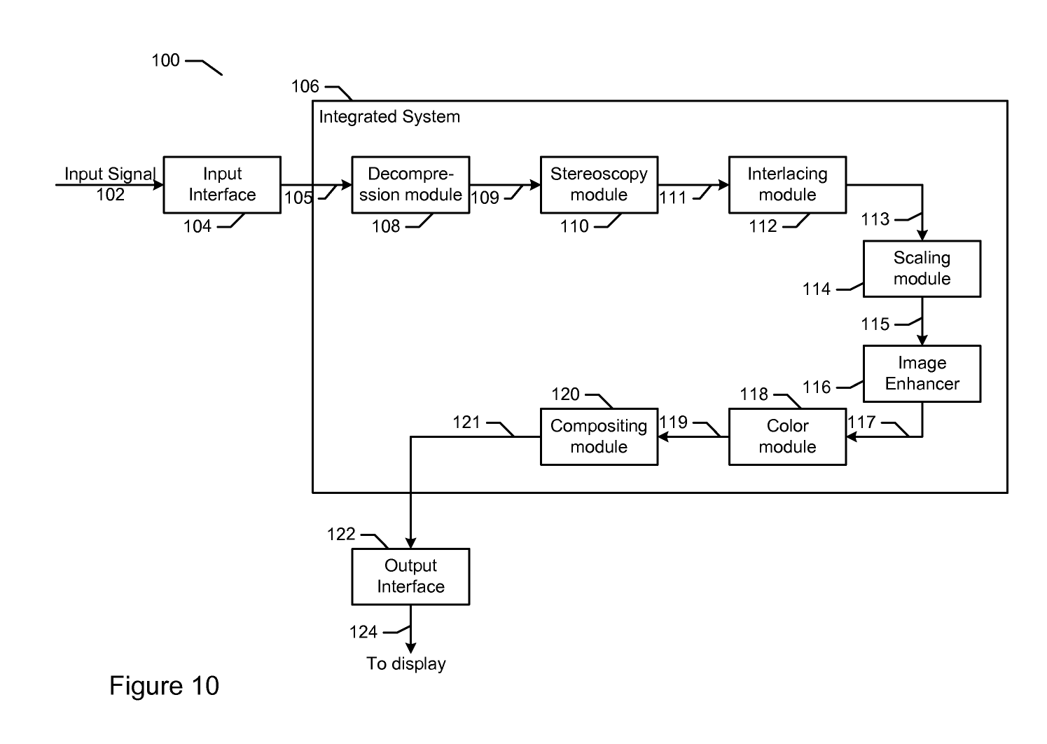

An exemplary architecture for receiving and processing a compressed image stream will now be described with reference to FIG. 10. For the purpose of this example, the architecture will be described in the context of a digital television; however it is to be appreciated that the techniques described herein may be used in a number of contexts. The architecture 100 may be a television controller. In this example, the architecture 100 is integrated in a digital television. As shown, architecture 100 comprises an input interface 104, an integrated system 106 and an output interface 122.

The input interface 104 receives an input signal 102 from a source. The input signal 102 carries an image stream. In particular, the input signal comprises information usable to recover a frame sequence. The source may be one or more of many kinds of sources of an input signal, such as for example an S-Video input, an HDMI input, a USB input, a VGA input, a component input, a cable/sat input, an SD card input or any other suitable input capable of providing an input image stream. The input interface 104 may comprise any appropriate tuning, demodulation and decrypting logic, and any other logic required to recover an input digital image stream from the input signal received from the source. Furthermore, the input interface 104 can perform other functions such as detect an identification signal providing information on the incoming data (e.g. format information). The presence of such information depends on the particular input interface and format used, and on the source of the input signal 102. The input interface 104 may receive such information and provide it to the integrated system 106 to inform the way the input signal should be processed.

The architecture 100 also comprises logic for processing a received input image stream. An integrated system 106 performs decompressing and decoding functions as well as other image processing functions as required. In the present example, the integrated system 106 is a system-on-a-chip (or SoC) which comprises several modules for performing different functions. In particular, in this example the integrated system comprises a decompression module 108, a stereoscopy module 110, an interlacing module 112, a scaling module 114, an image enhancer 116, a color module 118 and a compositing module 120.

It will be appreciated that the architecture 100 is merely exemplary and that certain modules in the integrated system 106 may be omitted. As will be described below, the organisation of these modules, as shown in FIG. 10, is also exemplary only; in other embodiments, these modules may be organized differently. For example, they may be ordered differently, or provided in a non-linear fashion. While shown here in a daisy-chained output-to-input configuration, it will be appreciated that this is for illustrative purposes only, as the interaction between modules depends on the particular implementation of the integrated system. For example, the modules may communicate in a hardware implementation via datelines or a bus or in software by nested function calls or by shared or global variables or in by any other suitable means. Furthermore, the functionality and logic of the modules, which will be described further below, may be distributed differently into modules, and the functionality of certain modules may be linked to form one single module in the place of two illustrated modules.

The integrated system 106 is implemented as a system-on-a-chip which may include one or more microcontroller, microprocessor or DSP core, memory, external interfaces and analogue interfaces. The integrated system may comprise internal memory and/or external memory, such as an external RAM module. Furthermore, while the present example comprises an SoC comprising all the modules shown in FIG. 10 as being internal to the integrated system 106, it is to be understood that any of these modules can be made external to the SoC and rather interface therewith. Likewise, the input interface 104 and output interface 122 that have been shown as external to the integrated system 106 could be contained within the SoC, provided that the SoC is capable of replicating the functions of input and output interfaces 104, 122 internally.

Of course, an integrated system 106, in the form of an SoC or otherwise could be substituted with other suitable alternatives, such as individual hardware modules in communication with one another. Alternatively, it could be composed entirely or partially of software logic running on, e.g. a multi-purpose computer or DSP.

The various modules of the integrated system 106 will now be described. It is to be understood that depending on the implementation used, each module may take the form of hardware logic, implemented, for example as a module in an FPGA or of software logic, implemented for example as a software module which may comprise computer readable code including instructions for instructing a processor to perform certain tasks. Thus the implementation of the functions of the various modules may be said to be done using a processor by virtue of being performed a processor as a result of being so instructed by program instructions, or by being performed by dedicated hardware which processes data according to the function of the modules described herein.

In the present example, the digital image stream derived from the input signal 102 by the input interface 104 is a compressed frame sequence 105.

The compressed frame sequence 105 is provided to the integrated system 106 where it is decompressed by the decompression module 108 which is adapted to decompress the compressed frame sequence 105. An input digital image stream may be compressed according to a variety of compression formats such as MPEG2, MPEG4 or H.263. The decompression module 108 decompresses the input digital image stream 105 according to known methods and derives a decompressed frame sequence 109. Additionally, the decompression module 108 may derive information on the compressed frame sequence 105 and provide this information to other modules in the architecture 100, such as to the stereoscopy module 110. Any other processing or operations may be performed on the input digital image stream in order to prepare it for the stereoscopy module 110. As will be appreciated, the input digital image stream may also be an uncompressed frame sequence, e.g. if no MPEG (or other) compression is used, in which case the decompression module may be unused or entirely omitted.

Thus, at the output of the decompression module 108 is provided a decompressed frame sequence 109. In this non-limiting example, the decompressed frame sequence 109 is a single frame sequence. However, the decompressed frame sequence 109 may be a monoscopic single frame sequence or a stereoscopic single frame sequence. If the decompressed frame sequence 109 is a monoscopic frame sequence it may not require any further decoding. However, if the decompressed frame sequence 109 is a stereoscopic frame sequence, stereoscopic decoding might be required in order to recover a stereoscopic dual frame sequence.

The stereoscopy module 110 detects whether the decompressed frame sequence 109 is a stereoscopic or not. In this particular example, the stereoscopy module 110 detects whether the decompressed frame sequence 109 is a stereoscopic single frame sequence and, if so, which encoding format is used.

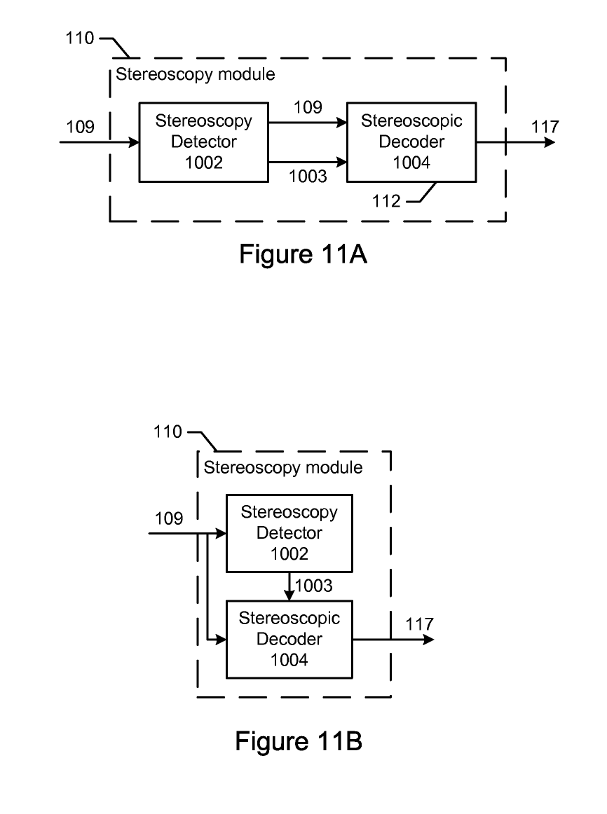

The stereoscopy module 110 is illustrated in FIG. 11a. As shown, the stereoscopy module comprises a stereoscopy detector 1002 and a stereoscopic decoder 1004. The stereoscopy detector 1002 has an input at which it receives at least a portion of the decompressed frame sequence 109, which in this example is a single frame sequence, and determines based on the received decompressed frame sequence 109 (or portion thereof received) whether the single frame sequence is a stereoscopic single frame sequence. The stereoscopy detector then informs the stereoscopic decoder if stereoscopy is detected. Here this is illustrated as connection 1003, which is an output of the stereoscopy detector 1002 and which in this example may be embodied by any suitable way of communicating between these two submodules (e.g. datalines or a bus or in software by nested function calls or by shared variables) but which in other examples may be any output suitable for other purposes, such as for communication with other modules, if the stereoscopy detector 1002 is meant to communicate the results of stereoscopy detection with other modules, or even for external communication if the stereoscopy detector is meant to communicate with elements outside the integrated system 106. If the stereoscopy detector 1002 detects stereoscopy, the stereoscopic decoder then decodes the decompressed frame sequence 109 to recover left and right frame sequences. In this particular example, if the single frame sequence is stereoscopic, the stereoscopy detector 1002 further determines an encoding format for the stereoscopic single frame sequence and communicates this determined format to the stereoscopic decoder 1004 as well. The stereoscopic decoder 1004 uses this knowledge to select a decoding scheme according to which to decode the decompressed frame sequence 109.

For the purposes of this example, it will be assumed that the stereoscopy detector 1002 receives and/or has access to the entire decompressed frame sequence 109, however it will be understood that in an alternate embodiment, the integrated system 106 could be configured such that the stereoscopy detector 1002 receives only one or more discrete part of the decompressed frame sequence 109 and performs stereoscopy detection as described herein based on this one or more received part of the decompressed frame sequence 109.

The stereoscopy module 110 may output an output indicative of whether the stereoscopy detection performed by the stereoscopy detector. For example the stereoscopy detector 110 may output the result provided over connection 1003. In this example, the stereoscopy module 110 comprises stereoscopic decoder 1004 which performs stereoscopic decoding on the decompressed frame sequence 109 if it is found to be stereoscopic. The resulting decoded frame sequence may itself serve as the indication of the result of stereoscopy detection. In particular, if the stereoscopy module 110 output a dual frame sequence, this may be interpreted as an indication that the decompressed frame sequence 109 is stereoscopic.

It is to be understood that the structure of the stereoscopy module 110 shown in FIG. 11a is purely exemplary, another exemplary structure being shown in FIG. 11b. Moreover, the stereoscopy detector 1002 may be in communication with other modules that may require information regarding the decompressed frame sequence 109. Alternatively still information regarding the stereoscopic or non-stereoscopic nature of the decompressed frame sequence 109, including format information, may be communicated within the integrated system in any suitable manner including by embedding information within the sequence itself.

It should also be understood that the stereoscopy detector 1002 and the stereoscopic decoder may be separate. In other embodiments, other modules may be located (logically or physically) between the stereoscopy detector 1002 and the stereoscopic decoder 1004. In fact, in certain embodiments, the architecture may only provide detection, not decoding, of stereoscopy and/or format. In such cases the stereoscopic decoder 1004 may be entirely absent.

Although in this example the stereoscopy module 110 receives a single frame sequence that is a decompressed frame sequence, it is to be understood that the decompression stage is optional. In alternate examples, there may be no decompression, the input interface 104, receiving an uncompressed single frame sequence. Alternatively still, the stereoscopy detector 1002 may analyse a compressed frame sequence 105 to detect stereoscopy therein. This may be done by observing encoded motion data (e.g. the motion vectors in P-frames) and observing if there is a tendency for these motion vectors not to cross the vertical center line of frames (side-by-side detected) or the horizontal center line of frames (above-bellow detected). Moreover line- or column-interleave may be detected, for example, by observing the residual differences within macroblocks of P-frames.

Returning to the example of FIG. 11a, here the stereoscopy detector 1002 is a multi-format stereoscopy detector 1002, which is capable of detecting stereoscopy in a plurality of stereoscopic encoding formats. The decompressed frame sequence may be monoscopic, or may be stereoscopic and encoded in a merged frame format which may be side-by-side, above-below, line-interleave, column-interleave, L-corner or tile format, or in a frame sequential format. In order to be able to detect stereoscopy despite the variety of possible encoding formats of the decompressed frame sequence 109, the stereoscopy detector 1002 may apply several tests on the decompressed frame sequence 109, each test being able to detect stereoscopy in at least one encoding format. The different tests may be applied simultaneously in parallel, or one after another, or a combination of both. The tests may provide a simple result of stereoscopic or non-stereoscopic, or may provide a level of confidence of detection of stereoscopy or monoscopy. Determination of stereoscopy may be based on whether a particular threshold of confidence has been detected by a test. If the tests are run in sequences, testing may be halted if a certain certainty threshold is found. Furthermore, the stereoscopy detector 1002 may detect stereoscopy or a particular encoding format on the basis of multiple performances of a test at different points in time. The stereoscopy detector 1002 may aim to achieve itself require a particular level of certainty of detection of stereoscopy or stereoscopic format prior to signalling a change, for example by tracking the result of several instances of a test over time.

Detection of stereoscopy or monoscopy may be performed by the stereoscopy detector 1002 by performing particular tests. Each test may be intended to detect stereoscopy according to a particular one or more stereoscopic encoding format. For example, a side-by-side test will be described below, according to which the stereoscopy detector 1002 may detect whether the decompressed frame sequence 109 is a stereoscopic single frame sequence encoded in a side-by-side encoding format. Other tests may be run by the stereoscopy detector 1002 to detect whether the decompressed frame sequence is a stereoscopic single frame sequence encoded in other formats. Monoscopy may be detected by the stereoscopy detector 1002 by specific monoscopy tests, or simply by finding the failure of stereoscopy test(s) to detect stereoscopy.

In a stereoscopy test, the stereoscopy detector 1002 may first select a first and a second portion of the decompressed frame sequence 109 where it is expected to find data derived from a left and corresponding right frame if the decompressed frame sequence 109 is stereoscopic. The location in the decompressed frame sequence 109 of the first and second portions may depend on the particular format of stereoscopic encoding expected or being detected. For example, if a merged the test is intended to detect stereoscopy in a merged frame format, the first and second portions may be at or within an expected location of subframes in a merged frame. The first and second portion may thus be within a same frame, although not necessarily so in the case of merged frame formats that do not carry corresponding left and right frame data in a same merged frame (see, for example FIG. 5A). In another example, if the stereoscopy detector 1002 is configured to detect stereoscopy in a frame sequential format, the first and second portions selected will be in different frames. The first and second portions selected may be an entire region where left and right frame data is expected to be found if the frame sequence is stereoscopic (i.e. an entire subframe for merged frame formats, or an entire frame for frame sequential formats) or may be only a portion of such a region.

The first and second portion may be smaller than a frame, e.g. if the test is intended to detect stereoscopy in a merged frame format (the first and second portions may be subframe-sized or smaller) or may be substantially the size of a frame, e.g. for frame sequential formats.

The selected first and second portions are then compared to one another in order to ascertain whether their content is likely from a same pair of corresponding left and right frames or whether they more likely represent different portions of a monoscopic frame sequence. This may be done in any suitable manner, but in a non-limiting example, the first and second portions are analysed for similarity in a segment-by-segment manner. For this, a plurality of segments are selected for the first and second portions, either by defining new segments (e.g. blocks of pixels) or by selecting inherent segments (e.g. lines of pixels), and segments of the first portion are compared to corresponding segments of the second portion. The segment comparison may take place on a pixel-by-pixel basis or may be done by comparing a characteristic value computed for each segment. Segment comparisons may return a match/no-match result or a measure of similarity between segments. For the overall portion comparison, the Stereoscopy detector 1002 may consider the result of the segment comparison, e.g. by counting a number of segment comparison for which a match was found, or by taking a function of similarity measures. The portion comparison may then return a Boolean value indicative of whether stereoscopy (of the particular encoding tested-for) was found, or a value indicative of level of confidence that stereoscopy was found.

A particular stereoscopy test will now be described in accordance with a non-limiting example. The stereoscopic detector 1002 is configured to perform this test to detect if the decompressed frame sequence 109 is a side-by-side stereoscopic frame sequence.

To begin with, the stereoscopic detector 1002 selects a first and a second portion of the decompressed image stream 109. In this particular example, frame F₀₁ of the example of FIG. 3 has been received by the stereoscopic detector, which is a side-by-side encoded stereoscopic frame encoded according to a particular scheme which provides no gap between the left and right subframe. Each subframe takes up an entire half of the frame. The stereoscopy detector 1002 is adapted to detect stereoscopy according to this encoding scheme using a side-by-side stereoscopy test. In accordance with the side-by-side stereoscopy test, the stereoscopy detector 1002 selects the left half 302 of frame F₀₁ as first portion and the right side, 304 of frame F₀₁ as second portion.

The stereoscopy detector 1002 then performs a portion comparison to detect whether the first and second portions are derived from corresponding left and right frames. In this particular case, the stereoscopy detector will check whether the first and second portions are entire left and right subframes, which according to the side-by-side encoding format, are derived from left and right frames. In this example, the stereoscopy detector 1002 considers the entire regions of left and right subframes according to the side-by-side format in question; however, in alternate embodiments, the first and second portions may only cover a part of the subframe. It may still be possible to derive a reasonably accurate detection of stereoscopy looking at only a part of the subframe regions.

The stereoscopy detector 1002 is operative to compare the first portion 302 to the second portion 304 and to determine, on the basis of this comparison, whether the frame F₀₁ is a side-by-side merged frame.

The stereoscopy detector 1002 selects a plurality of segments in each of the first and second portions 302, 304 and for each of the first portion 302's segments, it performs a segment comparison with a corresponding one of the second portion 304's segments. In this particular non-limiting example, the segments consist of lines within the portions. The stereoscopy detector 1002 therefore verifies each line of the frame F₀₁ and determines for each horizontal line of the frame F₀₁ if a match exists between the pixels of the left half of the horizontal line and the pixels of the right half of the horizontal line. On a basis of these determinations, the stereoscopy detector 1002 concludes whether the frame F₀₁ is a side-by-side merged frame.

More specifically still, the stereoscopy detector 1002 is operative to divide the frame F₀₁ into first and second portions 302, 304, the first portion 302 consisting of half of the vertical lines of the frame (VL₁-VL₃), the second portion 304 consisting of the other half of the vertical lines of the frame (VL₄-VL₆). For each portion, the stereoscopy detector 1002 computes an average value of a characteristic pixel parameter (in this example, luminance) for each horizontal line of the respective sub-frame (HL₁-HL₆). The stereoscopy detector 1002 then compares, for each horizontal line (H_{L1}-H_{L6}) of the frame, the average value of the characteristic pixel parameter computed for the first portion 302 to the average value of the characteristic pixel parameter computed for the second portion 304. The stereoscopy module 1002 then verifies whether the two computed averages are within a certain threshold of one another and if so, it determines that here is substantial match between two segments. If not, the stereoscopy detector 1002 determines that there is no match. Thus, the result of the segment comparison is a Boolean. On a basis of these comparisons, the stereoscopy detector 1002 detects if the frame is a side-by-side merged frame and outputs a signal indicative of a result of this detecting. More specifically, if a match is found between the average characteristic pixel parameter computed for the left and right halves of at least a certain proportion of the horizontal lines of the frame (in this example, at least a majority thereof), the stereoscopy detector 1002 outputs a signal indicative of a stereoscopic format. In this example, since the stereoscopy detector performs detection for multiple encoding formats, it will output a signal indicative specifically of the detection of the side-by-side stereoscopic format). Otherwise, the stereoscopy detector 1002 may outputs a signal indicative of a non-stereoscopic, two-dimensional frame, if no other encoding mode are to be detected, however in this particular example, if side-by-side encoding is not detected, the stereoscopy detector 1002 will test for other formats.

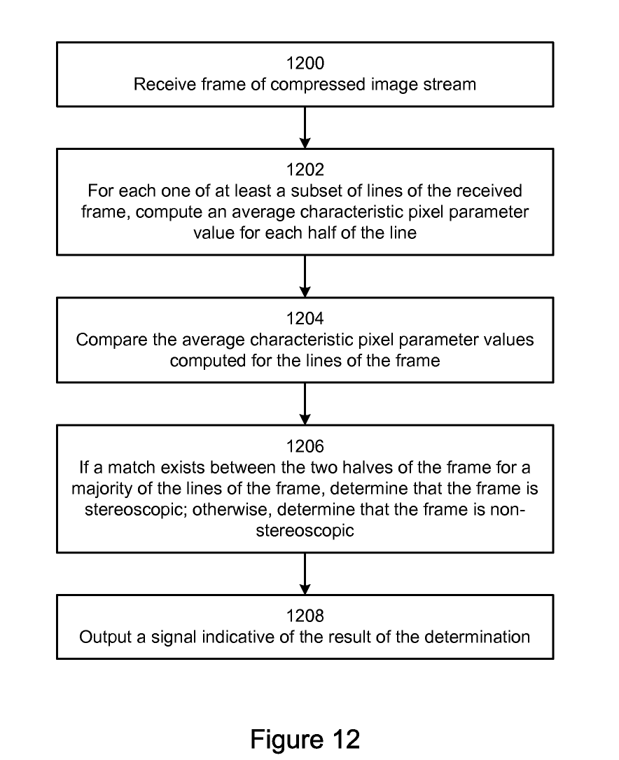

FIG. 12 is a flow diagram illustrating the processing implemented by the stereoscopy detector 1002 for the above-described test, according to a non-limiting example of implementation of the present invention. At step 1200, a frame of the decompressed frame sequence 109 is received by the stereoscopy detector 1002. At step 1202, first and second portions of the frame are selected, each comprising a certain number of segments in the form of half lines of the frame. These are selected such that they form together at least a subset of whole lines of the frame. For each one of the at least a subset of the lines of the received frame, an average characteristic pixel parameter value is computed for one half of the respective line (segments of the first portion) and for the other half of the respective line (segments of the second portion). At step 1204, the average characteristic pixel parameter values computed for the lines of the frame are compared. If a substantial match exists between the two halves of the frame for at least a majority of the lines of the frame, the frame is determined to be stereoscopic at step 1206; otherwise the frame is determined to be non-stereoscopic. A signal indicative of the result of this determination is generated and output at step 708.

Note that after the computation of the average characteristic pixel parameter values, the comparison of these values and the determination of the type of frame may be performed by the stereoscopy detector 1002 according to different sequences of operations, without departing from the scope of the present invention. For example, in the case of side-by-side frame F₀₁, the stereoscopy detector 1002 may first compute the average characteristic pixel parameter values for all of the at least a subset of horizontal lines of the frames, prior to comparing the computed average characteristic pixel parameters for each horizontal line. Alternatively, the stereoscopy detector 1002 may perform the computation of the average characteristic pixel parameter values and the comparison of these computed values (in order to determine if a match exists) on a line-by-line basis (i.e. one horizontal line at a time). In the latter case, it may be possible for the stereoscopy detector 1002 to determine if a frame is stereoscopic or non-stereoscopic without having to analyze all of the at least a subset of horizontal lines of the respective frame.

In practice, the frame dividing, average characteristic pixel parameter computation/comparison and match determination steps described above may be implemented automatically within the integrated system 106 using appropriate hardware and/or software that could, for example, read the appropriate pixels from each frame, perform the necessary computations and temporarily store the computation results in memory during the comparison and match determination operations. More specifically, the stereoscopy detector 1002 of the integrated system 106 may access, store data in and/or retrieve data from a memory, either within the integrated system 106 or remote to it (e.g. a host memory via bus system), in the course of performing the frame dividing, average characteristic pixel parameter computation/comparison and match determination operations. Pixel information is transferred into and/or read from the appropriate memory location(s) during these operations.

In a specific, non-limiting example of implementation, the characteristic pixel parameter is luminance (e.g. “Y” of YUV or YCbCr format). Taking for example the case of frame F₀₁, for each horizontal line of the frame F₀₁, the stereoscopy detector 1002 computes a first average luminance value for the pixels of V_{L1} to V_{L3} (first portion 302) and compares this to a second average luminance value for the pixels of V_{L4} to V_{L6} (second portion 304). More specifically, for first portion 302, the stereoscopy detector 1002 computes an average luminance value for HL₁ by averaging the luminance values of firs portion pixels (L1₀, P2₀), (L1₀, P4₀) and (L1₀, P6₀), for HL₂ by averaging the luminance values of first portion pixels (L2₀, P1₀), (L2₀, P3₀) and (L2₀, P5₀), and so on for each of HL₃-HL₆. For second portion 304, the stereoscopy detector 1002 computes an average luminance value for HL₁ by averaging the luminance values of second portion pixels (L1₁, P1₁), (L1₁, P3₁) and (L1₁, P5₁), for HL₂ by averaging the luminance values of second portion pixels (L2₁, P2₁), (L2₁, P4₁) and (L2₁, P6₁), and so on for each of HL₃-HL₆. The stereoscopy detector 1002 compares the average luminance values computed for first portion 302 to the respective average luminance values computed for second portion 304, on a line-by-line basis, in order to determine if a match exists between the content of the left half of the image frame F₀₁ and the content of the right half of the image frame F₀₁.

In the example of a side-by-side compressed stereoscopic frame shown in FIG. 3, the average luminance of each horizontal line of the first portion 302 should be substantially the same as the average luminance of the corresponding horizontal line of the second portion 304, such that the stereoscopy detector 1002 will determine that the frame F₀₁ is stereoscopic. In the case of a non-stereoscopic, two-dimensional image frame, this same line-by-line comparison by the stereoscopy detector 1002 will typically not produce very many matches in average luminance between the left half of the frame and the right-half of the frame, such that the frame detector will determine that the frame is non-stereoscopic.

Alternatively, the characteristic pixel parameter that is used by the stereoscopy detector 1002 of the architecture 100 to compare the two halves of each frame is selected from the following group: contrast, hue, saturation, black level, color temperature, spatial frequency and gradient. Other pixel parameters are also possible and may be used without departing from the scope of the present invention.

In a specific, non-limiting example of implementation, the stereoscopy detector 1002 determines if the decompressed frame sequence is a stereoscopic frame sequence according to a side-by-side encoding format by computing a percentage of lines of the frame for which the absolute difference between the average value of the characteristic pixel parameter of the first portion 302 and the average value of the characteristic pixel parameter of the second portion 304 is below a predefined threshold value (i.e. the percentage of lines for which there is a substantial match between the average values of the characteristic pixel parameter of the first and second sub-frames). The stereoscopy detector 1002 then compares the computed percentage with a predefined reference percentage and, if the computed percentage is greater than the predefined reference percentage, concludes that the decompressed frame sequence 109 is indeed a stereoscopic frame sequence and outputs a signal indicative of this result. If the computed percentage is not greater than the predefined reference percentage, the result of said determining is that frame is a non-stereoscopic two-dimensional (2D) image frame and the output signal is indicative of this result or goes on to test for another stereoscopic encoding format. In one particular example, the predefined threshold is 10, while the predefined reference percentage is 91% (or 0.91). Thus, in this particular example, the stereoscopy detector 1002 will identify a line of the frame as being stereoscopic or three-dimensional (3D) if the absolute difference between the average characteristic pixel parameter value of the first sub-frame and the average characteristic pixel parameter value of the second sub-frame is less than 10. Furthermore, if the percentage of lines of the frame that are identified as being stereoscopic or 3D is greater than 91%, then the frame itself is determined to be stereoscopic. Note however that various different values for the predefined threshold value and the predefined reference percentage may be used without departing from the scope of the present invention.

Alternatively, the stereoscopy detector 1002 may simply count the number of segments of the selected portions (in this example, lines of the frame) for which a substantial match is found between the average characteristic pixel parameter of the first and second sub-frames, and compare this total count to a predefined reference number of lines in order to determine if the frame is stereoscopic or non-stereoscopic.

In a variant example of implementation, rather than determining the percentage of segments for which a match is found, the stereoscopy detector 1002 determines the percentage of segments for which no match is found and compares this computed percentage to a predefined reference percentage in order to determine if the decompressed frame sequence 109 is a stereoscopic frame sequence. Thus, the stereoscopy detector 1002 computes a percentage of lines of the frame for which the absolute difference between the average value of the characteristic pixel parameter of the first portion 302 and the average value of the characteristic pixel parameter of the second portion 304 is greater than a predefined threshold value (i.e. the percentage of lines for which there is no match between the average values of the characteristic pixel parameter of the first and second portions 302, 304). The stereoscopy detector 1002 then compares the computed percentage with a predefined reference percentage and, if the computed percentage is greater than the predefined reference percentage, concludes that the decompressed frame sequence 109 is not a side-by-side stereoscopic frames sequence and outputs a signal indicative of this result. If the computed percentage is not greater than the predefined reference percentage, the result of said determining is that frame is a stereoscopic image frame and the output signal is indicative of this result. In one particular example, the predefined threshold is 9, while the predefined reference percentage is 9% (or 0.09).

The stereoscopic decoder 1004 is responsive to the result signal output by the stereoscopy detector 1002 to decode the decompressed frame sequence 109 according to a side-by-side decoding format if the stereoscopic frame sequence is detected to be a side-by-side stereoscopic frame sequence.

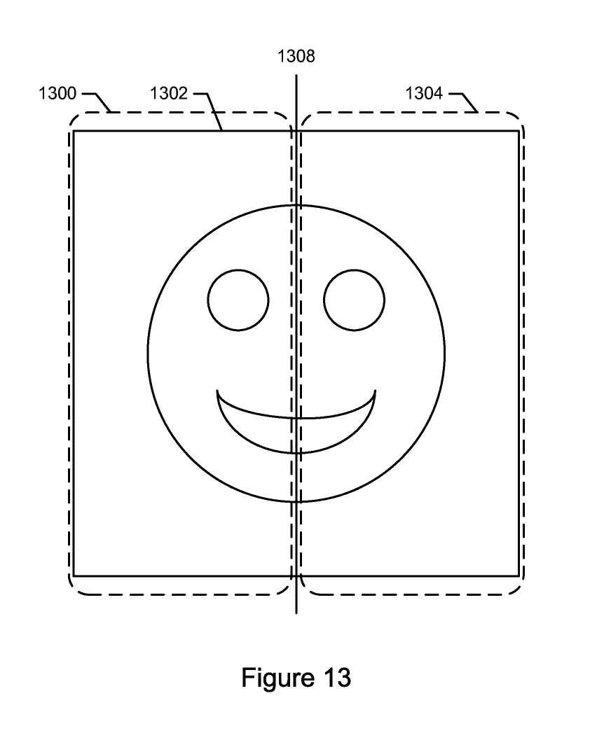

In a variant embodiment of the present invention, the stereoscopy detector 1002 is also configured to apply an exception algorithm to assess whether or not the pixels of each received frame are symmetric about a vertical centre of the frame. Taking for example the non-stereoscopic image frame 1300 illustrated in FIG. 13, a line-by-line average characteristic pixel parameter comparison between a first and second portion 1302, 1304 selected according to the above-described side-by-side stereoscopy detection test would lead the stereoscopy detector 1002 to erroneously conclude that the frame 1300 is a side-by-side merged frame. Accordingly, the exception algorithm applied by the stereoscopy detector 1002 to each frame analysed by the stereoscopy detector 1002 serves to assess the distribution of pixels about a vertical centre of the frame (shown as 1308 in FIG. 13), in order to determine whether or not the frame is symmetric. If the exception algorithm reveals that the frame is a symmetric one, the stereoscopic detector 1002 concludes that the frame is a non-stereoscopic, two-dimensional image frame and outputs a signal indicative of this result. The stereoscopy detector 1002 may apply this exception algorithm to each analysed frame before proceeding with the above-described operations for determining whether the respective frame is stereoscopic, since if the exception algorithm reveals that the respective frame is symmetric, the stereoscopy detector 1002 can immediately detect that the frame is not a side-by-side merged frame and proceed to conclude that the decompressed frame sequence 109 is non-stereoscopic or, if more formats are supported, perform tests for detecting other stereoscopic encoding formats.

In a non-limiting example of implementation, the stereoscopy detector 1002 determines if a received frame is symmetric, and thus non-stereoscopic, by computing a percentage of horizontal lines of the frame having pixels that are symmetric about a vertical centre of the frame. The stereoscopy detector 1002 then compares the computed percentage with a predefined reference percentage and, if the computed percentage is greater than the predefined reference percentage, concludes that the frame is indeed symmetric and outputs a signal indicative of detection of a non-side-by-side merged frame or goes on to test for other stereoscopic encoding formats. If the computed percentage is not greater than the predefined reference percentage, the result of said determining is that the frame is non-symmetric, in which case the stereoscopy detector 102 proceeds to apply the above-described operations for determining whether the frame is stereoscopic or non-stereoscopic. In one particular example, the predefined reference percentage used by the stereoscopy detector 102 for determining if a frame is symmetric or not is 50% (or 0.5); however various different values for this predefined reference percentage may be used without departing from the scope of the present invention. Alternatively, the stereoscopy detector 1002 may determine if a received frame is symmetric or not by computing a percentage of horizontal lines of the frame having pixels that are not symmetric about a vertical centre of the frame.

In a specific example, for each horizontal line of a received frame, the stereoscopy detector 1002 applies a pair of subtraction operations to the pixels of the first and second sub-frames, in order to determine if the pixels of the respective line are symmetric or non-symmetric about the vertical centre of the frame. More specifically, taking for example frame F₀₁ of FIG. 3, the following subtraction and comparison operations are performed for each line HLₓ (1≦x≦6) of the frame:

R1ₓ=|pixel(HLₓ,VL₁)−pixel(HLₓ,VL₄)|+|pixel(HLₓ,VL₂)−pixel(HLₓ,VL₅)|+|pixel(HLₓ,VL₃)−pixel(HLₓ,VL₆)|

R2ₓ=|pixel(HLₓ,VL₁)−pixel(HLₓ,VL₆)|+|pixel(HLₓ,VL₂)−pixel(HLₓ,VL₅)|+|pixel(HLₓ,VL₃)−pixel(HLₓ,VL₄)|
if |R2ₓ−R1ₓ| is less than a predetermined threshold, the line HLₓ is identified as being of unknown orientation, otherwise:
   if R1ₓ>R2ₓ, the line HLₓ is identified as being symmetric (two-dimensional); otherwise:
      the line HLₓ is Identified as being non-symmetric and stereoscopic (three-dimensional).

Note that, alternatively, the stereoscopy detector 1002 may determine if a received frame is symmetric (and thus non-stereoscopic) or non-symmetric by computing a percentage of vertical lines of the frame having pixels that are symmetric about a horizontal centre of the frame, without departing from the scope of the present invention. This may particularly be useful in the context of a test intended to detect stereoscopy according to an above-below encoding format. The same subtraction and comparison operations as described above may be performed by the stereoscopy detector 1002 for each vertical line of the received frame, in order to determine if the vertical lines of the frame are symmetric or not.

In another variant embodiment of the present invention, when the average characteristic pixel parameter that is computed and compared by the stereoscopy detector 1002 for determining if a received frame is stereoscopic (3D) or non-stereoscopic (2D) is luminance, the stereoscopy detector 1002 may apply a correction algorithm to the average values of the characteristic pixel parameter computed for the segments (e.g. in this example, lines) of the first and second portions 302, 304 of the decompressed frame sequence 109, in the course of performing the above-described comparison operations. This correction algorithm accounts for a well-known and standard inconsistency that typically arises between the luminance of the left-eye and right-eye images at the time of stereoscopic recording of these images. More specifically, when capturing three-dimensional stereoscopic video, a rig with a beam splitter may be used, the beam splitter allowing to cut a light beam into two parts, one part going to the left camera and the other part to the right camera (e.g. cameras 12 and 14 of FIG. 1). Advantageously, the use of a beam splitter allows for a minimal camera inter-axial separation. Unfortunately though, a drawback of using such a beam splitter is that the light separation is imperfect and a difference in the brightness of the two light beam parts (i.e. the two images or eyes) is possible.

In a specific, non-limiting example of implementation, for each line of the received frame, the stereoscopic detector 1002 calculates a difference between the average values of the luminance (Y) computed for the first and second sub-frames. If the calculated difference is greater than zero but less than a predefined maximum difference, the stereoscopic detector 1002 will increase the lesser one of the two average values found by the calculated difference. Assume for example that the predefined maximum difference in luminance is 5 and, for a particular line of the frame, the average luminance Y₁ is 200 for the first portion and the average luminance Y₂ is 198 for the second portion. Accordingly, the absolute difference in Y for the left and right halves of the particular line is 2. Since this computed difference is less than the predefined maximum difference of 5, Y₂ is increased by 2, such that Y₂ is 200 and matches Y₁.

Another manner of dealing with the luminance disbalance is to configure the stereoscopy detector 1002 to compute the difference between the average luminance of each segment (e.g. line) or a portion with the average luminance of the portion as a whole, rather than to merely compute the average luminance of each segment. In other words, for each segment, after finding the average luminance, it is subtracted from the average luminance of the portion as a whole. The resulting values found for each segment represent a divergence at each segment from an average for the portion, which should be relatively unchanged by an overall increase or decrease in luminance. These values may be used to determine a match or a level of match between segments, rather than the average luminance for each segment.

Thus, as described above, the stereoscopy detector 1002 performs a segment-by-segment comparison for the segments of the first and second portions 302, 304. The stereoscopy detector 1002 performs the segment comparisons by calculating a characterising value describing the segment (in this case, an average luminance) by applying a particular function, which in this case is a statistical function on the pixels of the segments (and more specifically an average). It should be noted that in an alternate embodiment, the segment comparison may be done differently. It may not involve a direct pixel-by-pixel comparison of the pixels (or just a characteristic pixel parameter thereof) within the segment, or the calculation of another characterising value for the segment such as a color or luminance change gradient or any other characteristic of the segment. Moreover, the result of the segment comparison may be computed not to be a Boolean value but a level of match, such as a difference between the two averages computed for the segments. Alternatively still, a level of match could be calculated as a number of pixels that match (by some measure, e.g., in luminance value) in the two segments.

As described above, from the segment comparisons, the stereoscopy detector 1002 detects stereoscopy in format searched for. In particular, the stereoscopy detector 1002 determines a result of the detection based on a function of the results of the segment comparisons. In the example described above, the stereoscopy detector 1002 determines a Boolean detection result (side-by-side stereoscopy detected or not detected) based on the relative number of matching segments and non-matching segments (the majority being determinant). However it should be understood that any other manner of arriving at a Boolean detection result may be used. In particular, any function of the segment results may be computed to determine a stereoscopy detection result. For example, instead of a simple majority, a minimum ratio of matching segments to non-matching segments could be used or a minimum number of matches. If the segment comparisons provide non-Boolean results, a numerical function of the results could be used to determine the result of the portion comparison (e.g. portion comparison is a match if the sum of all the levels of match of the segments is greater than X).

Although in the example above the result of the portion comparison is a Boolean (stereoscopy—according to the tested format—detected or not), it is to be understood that a level of confidence of detection may be provided instead of or as well as the Boolean detection value. The level of confidence may be calculated as a function of the segment comparison results (e.g. a percentage matching the number of Boolean matches found in the segment comparisons or a number reflecting an overall level of match found).

Note again that, alternatively, the stereoscopy detector 1002 may perform this pixel comparison and match determination for a subset of the horizontal lines of the frame F₀₁, rather than for all of the horizontal lines of the frame F₀₁. For example, the stereoscopy detector 1002 may perform the pixel comparison for only the even-numbered horizontal lines, or only the odd-numbered horizontal lines, of the frame F₀₁.

It is also to be understood that while the above example segment comparison was performed on segments having the form of lines (which, it should be mentioned, may have single pixel in width or more), other shaped segments may be used such as blocks or columns. However, the choice of which segment from the first portion to compare with which segment from the second portion should be based on an expectation that if the frame is encoded in the tested format, the pairs of segments compared will correspond to substantially similar areas of respective left and right frames.

Advantageously, comparing portions in a segment-by-segment manner allows a greater accuracy of detection. In particular, if the effects of individual segments in a comparison are ignored, as would be the case if entire portions are compared, there may be inaccurate results. For example, if functions of entire portions are compared, then different segments within the portions may cancel out or different segments in two different portions may contribute equally to the result of the function, though they be not corresponding segments in the portion, which could lead to an incorrect finding of stereoscopy.

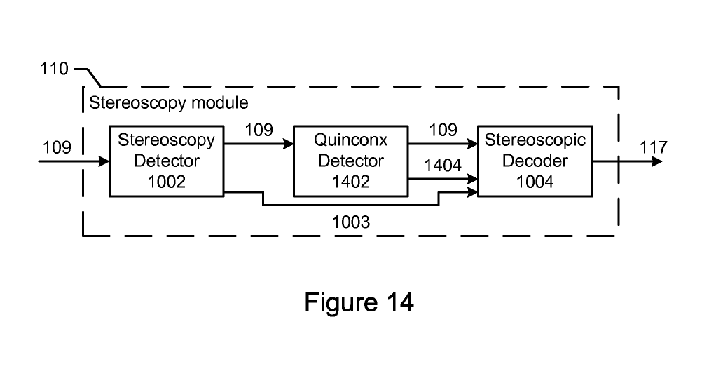

Upon detecting a side-by-side encoding format, the stereoscopy detector 1002 further performs a quincunx detection. This may be performed by a separate quincunx detector 1402 module within the stereoscopy detector 1002 or external to the stereoscopy detector 1002, as shown in FIG. 14. Though shown separately here, the quincunx detector 1402 could be within the stereoscopy detector 1002. In quincunx detection, the stereoscopy module applies a quincunx test to determine whether the detected side-by-side encoding for the decompressed frame sequence 109 is a quincunx side-by-side encoding.

The quincunx detector 1402 selects a test portion of the decompressed frame sequence 109 and analyses it to detect whether the frame shows signs of quincunx decoding. The test portion is a frame or a portion of a frame, although the quincunx detector 1402 may test several test portions for greater accuracy.

In a first non-limiting example, the quincunx detector 1402 detects quincunx encoding in the frequency domain. In particular, the quincunx detector 1402 transforms the test portion into the frequency domain using any suitable techniques. In this example, it performs a fast fourier transform (FFT) on the test portion. In this example, only the luminance value is used in the transform, and the resulting frequency-domain frame is a representation of only the frequency domain of the luminance of the pixels of the test portion. Of course, other characteristic pixel parameters could be used instead or as well. For example, an RGB color value could be used.

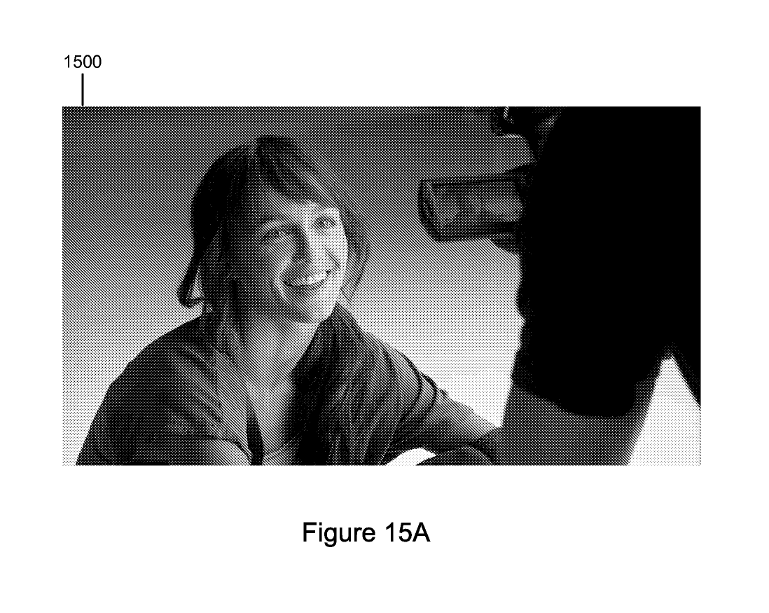

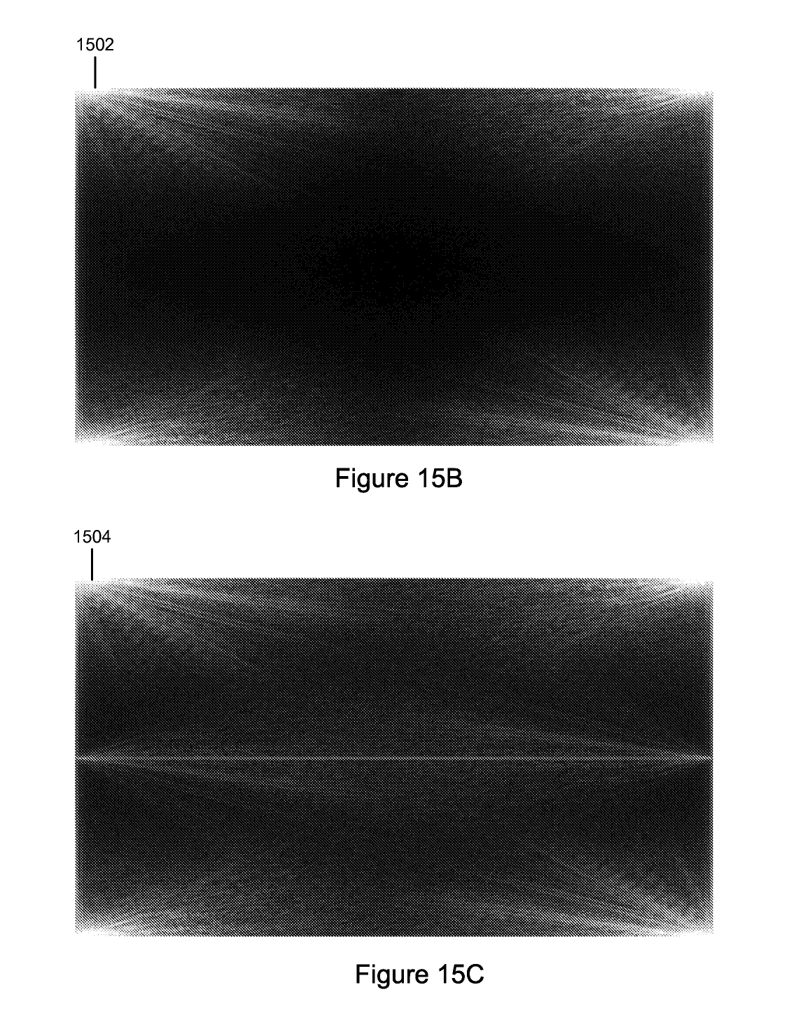

FIG. 15A shows left image 1500 of a stereoscopic dual image stream. FIGS. 15B and 15C illustrate a frequency domain merged frame based on the left image 1500 and its corresponding right image, encoded according to a non-quincunx side-by-side format (FIG. 15B, frame 1502) and according to a quincunx side-by-side format (FIG. 15C, frame 1504). It has been found that if a frame is a quincunx side-by-side merged frame it will have a higher density of high frequencies than if it was encoded in non-quincunx side-by-side. In particular, it has been observed that there will be a higher standard deviation amongst the values at the center of the frequency domain frame 1504 for the quincunx side-by-side encoded merged frame, than for the non-quincunx side-by-side encoded merged frame 1502.

In order to detect quincunx side-by-side encoding, the quincunx detector 1402 first selects a central portion of the frequency domain frame 1504. In this example the central portion selected lies between the ⅜^{th} and ⅝^{th} of the height of the frequency domain frame 1504 and the ⅜^{th} and ⅝^{th} of the width of the frequency domain frame 1504. The quincunx detector 1402 selects this central portion and measures the average and standard deviation of the values therein. It then compares the values to a particular threshold. In this example, the value 970 has been used as a threshold to discriminate between quincunx side-by-side and non-quincunx side-by-side. In particular when the standard deviation of the above-defined central portion of a side-by-side merged frame is above 970, the quincunx detector 1402 determines that the side-by-side merged frame being tested is a quincunx-encoded side-by-side merged frame. Under that threshold it determines that the merged frame is a non-quincunx side-by-side merged frame.

It is to be understood that he values of the dimensions of the central portion and of the threshold used are purely exemplary and other values may be used. Furthermore, other segments may be used other than the central portion, although this one has been found to be the most advantageous. Likewise other manners of detecting quincunx based on the frequency domain may be used, such as measurements of other functions, other than the standard deviation. Moreover, it is to be understood that although an entire frame was transformed to the frequency domain for this example, the quincunx detector 1402 may transform only a portion of a frame instead.

On the basis of the determination that one or more side-by-side merged frame is a quincunx side-by-side merged frame, the quincunx detector 1402 may come to a conclusion as to whether the decompressed frame sequence 109 is a quincunx side-by-side merged frame sequence. It may then it may output an indication 1404 of this conclusion, e.g. to the stereoscopic decoder, such as to allow the stereoscopic decoder to process the decompressed merged frame accordingly. In particular, if the decompressed frame sequence 109 is a quincunx side-by-side merged frame sequence, the decoder may decode the decompressed merged frame sequence 109 according to a quincunx decoding scheme whereby the left and right subframes are split and decollapsed into a quincunx pattern and the missing pixels are interpolated from the existing pixels. The quincunx detector 1402 may output an indication of its conclusion in any suitable manner and to any suitable recipient.

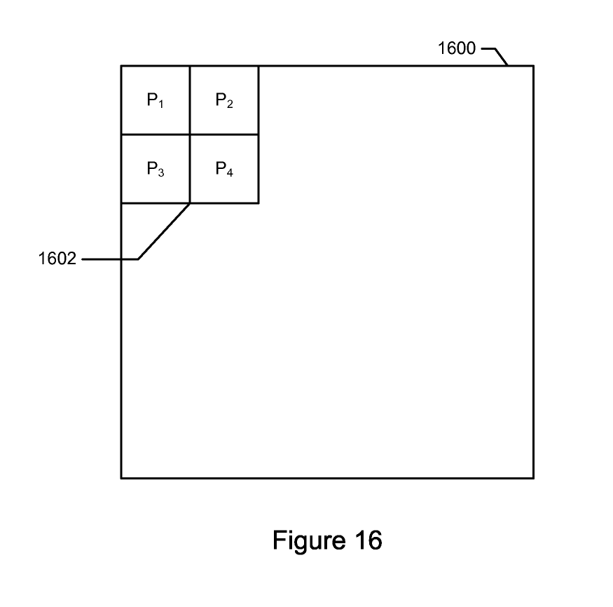

In a second non-limiting embodiment, the quincunx detector 1402 may detect whether a side-by-side frame sequence is a quincunx side-by-side frame sequence in the regular spatial domain. In this example, the quincunx detector 1402 may perform a jagged line detection algorithm. Quincunx decimation followed by collapsing tends to incorporate jagged “staircase” line patterns in the image. These “staircase” patterns have stairs that are one pixel wide and high. Thus by a suitable algorithm observing adjacent pixels of a whole, or a suitably large portion of a frame, it is possible to detect whether the frame was encoded using quincunx decimation or not. Any suitable algorithm may be used; however, in this example the quincunx detector 1402 follows the following series of steps, with reference to FIG. 16. First, it selects the top left four pixel square 1602 of the test portion 1600. For the purpose of this example, these pixels, and their luminosity values shall be called P1, P2, P3 and P4, as shown. It then finds the following values f1, f2, f3 and f4 based on these pixels as follows:

f1=|(P1+P2)−(P3+P4)|

f2=|(P1+P3)−(P2+P4)|

f3=|(f1−f2)/2|

f4=∥P2−P3|−|P4−P1∥

Where “∥” designates an absolute value. Furthermore a value “result” and a value v1 is found as follows:

Result f4−f3

v1=|P1−P2|

Now if the value of v1 is above a certain threshold, in this example 3, than a value is attributed for that particular square location, which is 1 if the value of “result” is positive, −1 if the value of “result” is negative and zero if the value of “result” is zero. If v1 is below the threshold, the value attributed for that particular square location is zero.

Now these steps are repeated for every possible location of the square (four adjacent pixels) in the test zone, each time assigning a value to the location of the square. (In other words, the square 1602 is shifted by one pixel and the above operation is repeated; it is to be understood that a subset of all possible locations of the square 1602 could be used, e.g. it could be shifted by more than one pixel at each iteration.) Once all the possible square locations have been tested, than the sum of the values attributed to all the square locations is found, and if it is greater than the number of pixels in the test zone, the quincunx detector 1402 determines that the frame being examined is a quincunx side-by-side merged frame, otherwise it determines that the frame being examined is not a quincunx side-by-side merged frame.

The remainder of the detection is the same as in the frequency domain example above. The quincunx detector 1402 may form a conclusion as to the decompressed frame sequence 109 and generate an output based thereon.

The above example is exemplary only and any other suitable manner of detecting jagged “staircase” pixel patterns, or quincunx in general may be used.

It should be noted that quincunx detection is optional and the stereoscopy decoder 1002 needs not detect quincunx specifically.

In addition to performing a test to detect stereoscopy according to a side-by-side merged frame format, the stereoscopy detector 1002 also performs a test to detect stereoscopy according to at least one other format. In this manner, the stereoscopy detector 1002 is able to detect stereoscopy in an input frame sequence that may be monoscopic or stereoscopic when the stereoscopy can be in a plurality of formats.

In a second test, the stereoscopy detector 1002 detects stereoscopy according to an above-below encoding format. For this test, the stereoscopy detector 1002 is configured to select two other portions of the decompressed frame sequence 109. In particular, the stereoscopy detector 1002 selects two portions in the subframe regions of an above-below encoding format, that is a first and second portion within portions within an above and a below region respectively (e.g. top half and bottom half of the frame, for above-below formats wherein the frame is split evenly down the middle). The stereoscopy detector 1002 is configured to then compare the so selected first and second portion to determine, on a basis of this comparison, whether or not the decompressed frame sequence 109 is a stereoscopic frame sequence. This may be done in a manner similar to that described for detection of a side-by-side stereoscopy, above. In a specific, non-limiting example of implementation, the stereoscopy detector 1002 is operative to divide the frame into two sub-frames, the first sub-frame consisting of half of the horizontal lines of the frame (e.g. the top half), the second sub-frame consisting of the other half of the horizontal lines of the frame (e.g. the bottom half). If the above-below encoding format of the test calls for a gap between the above and below subframes, this gap may be omitted from the selected portions. The stereoscopy detector 1002 then determines for at least a subset of the vertical lines of the frame if a match exists between the pixels of the first sub-frame and the pixels of the second sub-frame. In this example, the segments of the first and second portions may therefore be vertical lines instead of horizontal lines as described. On a basis of these determinations, the stereoscopy detector 1002 determines whether the decompressed frame sequence 109 is stereoscopic (according to an above-below encoding format) or not. More specifically, if a match is found between the average characteristic pixel parameter computed for the top and bottom halves of at least a majority of the vertical lines of the frame, the stereoscopy detector 1002 outputs a signal indicative of a compressed stereoscopic frame. Since the stereoscopy detector 1002 is configured to detect stereoscopy according to different encoding format, it will also include an indication of the format detect, although this may be omitted in embodiments where the stereoscopy detector 1002 is configured to detect one format only, or if it is operative to be instructed to perform a specific detection for a specific encoding format (in which case the instructing entity will already know which format was being detected). If stereoscopy according to an above-below format is not detected, the stereoscopy detector 1002 may outputs a signal indicative that stereoscopy according to an above-below format was not detected, or if only one format is being tested, that the decompressed frame sequence 109 is a non-stereoscopic two-dimensional frame sequence.

Although the side-by-side stereoscopy test and the above-below stereoscopy test have been described here as two separate tests, it will be appreciated that test may be combined in certain ways. For example, one of the first and second portions used for the side-by-side stereoscopy test may be used for the above-below test if it is suitably selected to be located in a subframe region of both a side-by-side merged frame and an above-below merged frame. For example, the top left corner of a frame may be used to as the first portion of both the side-by-side stereoscopy test and the above-below stereoscopy test, the second portion being the top right corner for the side-by-side stereoscopy test and the bottom left corner for the above-below stereoscopy test.

Moreover, although the side-by-side and above-below tests have generally been described a sequentially performed, it is to be understood that these and other stereoscopy detection tests may be performed in parallel as well.

It should also be noted that while the above example have selected the first and second portions from within a same frame, so as to detect a true side-by-side or above-below format, the first and second portions could be selected from different frames of the decompressed frame sequence 109 if it is expected that a stereoscopic frame would be in a non-true side-by-side or above-below encoding format. In a non-true merged frame format, the subframes derived from corresponding left and right frames may not be in the same merged frame. Stereoscopy according to non-true side-by-side, above-below, or other merged frame format may be tested for in separate tests, additional to the true side-by-side and above-below test formats described above.

In a non-limiting example, tests for true and non-true merged frame formats may be combined. To this end, the stereoscopy detector 1002 may select a single first portion within a first frame of the decompressed frame sequence 109, and several second portions in different frames of the decompressed frame sequence 109. The stereoscopy detector 1002 may then perform portion comparison between the first portion and each of the second portions separately and identify stereoscopy if any one of the comparisons results in a detection. Moreover if stereoscopy is detected, the stereoscopy detector 1002 may output a signal indicating which of the second frames lead to the detection, or more simply, which non-true format was detected. Advantageously, using several second frames may allow stereoscopy detection even in the cases where frame mismatch has occurred. Frame mismatch is an error that occurs during encoding whereby a left frame and its corresponding right frame are not encoded into the same merged frame even though the encoding is meant to generate a true merged frame format.

In an example of a non-true side-by-side stereoscopy test, the stereoscopy detector 1002 may specifically detect the side-by-side format defined in FIG. 5A by selecting first and second portions from a same side of two time-adjacent frames.

In addition to the side-by-side and above-below formats, the stereoscopy detector 1002 also runs test to detect a number of other formats including line-interleave, column-interleave, tile and L-shaped encodings.

It will be appreciated that for these formats, the stereoscopy detector 1002 may select first and second portions that are non-continuous to reflect the subframe regions of the merged frames of these formats. Nonetheless, the above-described techniques may be used to detect stereoscopy. For formats where the different subframes are not of the same shape, such as the L-shape format, if a segment-by-segment comparison is employed, corresponding segments must be identified based on the locations in each subframe region where data from a same area of left and right frames would be located if the decompressed frame sequence 109 is encoded in the tested format.

Moreover, for line- and column-interleave, rather than to test for symmetry, the stereoscopy detector 1002 may test for similarity or edge-continuousness between adjacent lines or columns. In particular, for detection of a line-interleave format the stereoscopy detector 1002 may employ edge-detection techniques to detect if vertical edges in a particular frame or portion thereof of the decompressed frame sequence 109. The stereoscopy detector 1002 may then look for a large number of discontinuities, a lack (or sparseness) of straight vertical edges, or a large present of jaggy vertical edges as signs that the frame may be in a line-interleave format. Looking for these signs may be done comparatively to horizontal edges in the frame or portion thereof, which will be less affected by line-interleaving. Similar techniques may also be used to detect column interleaving but with horizontal edges instead of vertical

Moreover, a line-interleave format may be detected in the frequency domain. In particular, a line interleave merged frame is likely to have a higher presence of high frequencies in the vertical direction. Accordingly, the stereoscopy detector 1002 may convert a frame or portion thereof of the decompressed frame sequence 109 to a frequency domain using fast fourier transform (FFT) or any other suitable transform and either directly observing the density of vertical high frequencies (e.g. by comparison to a threshold) or by comparing the density of vertical high frequencies to the density of horizontal high frequencies. Similar techniques may be used for column-interleaving, but looking at horizontal frequencies instead of vertical frequencies

In addition to, or instead of the above-described merged-frame detection techniques, the stereoscopy detector 1002 may detect a merged frame of a particular format by detecting discontinuities at the edges of the subframe regions according to the particular format. For example, to detect a side-by-side encoded frame, the stereoscopy detector 1002 observe the region of the vertical line that separates the left and right subframe in a side-by-side merged frame and detect edge discontinuities at this point, or a general pattern of change in color, luminosity or/and other pixel characteristics across that line. Moreover, if a predominance of black pixels is detected at the vertical line, this may be because the left and right subframe regions are surrounded by black, as may be caused merely by encoded left and right frames having a black contour. In such a case, the stereoscopy detector 1002 may perform the same detection but looking strictly at pixels on either side of the black line. This may similarly be done to detect other formats such above-below or tile formats, although the interface line will be located differently for these.

Although the above example have described test for detection of stereoscopy according to merged frame encoding formats, it will be appreciated that the stereoscopy detector 1002 may also test for stereoscopy according to a frame sequential format. For such a test, the first and second portions are located in different frames, and may consist of entire frames or only portions thereof. The actual portion comparison may be performed in a manner similar to that performed for other tests such as detection of stereoscopy according to a side-by-side encoding format.

Moreover, it will be appreciated that the test methodology presented herein may be used to detect stereoscopy in a dual frame sequence. In particular, if the stereoscopy detector 1002 is configured to receive frame sequences over two channels, it may detect whether a first and second frame sequence each received over a different channel are left and right frame sequences by selecting a first and a second portion from the first and second frame sequence respectively, and compare them according to any suitable comparison methods described above. The two portions may be substantially entire frames or portions thereof. If a stereoscopic dual frame sequence is expected to be frame-synchronized, that is, if it is expected that such a dual frame sequence would carry left frames and corresponding right frames simultaneously, the two portions are selected from simultaneous frames in the first and second frame sequence.

The stereoscopy detector 1002 may be configured to detect when a frame is substantially black or substantially white, or otherwise substantially monochromic and abstains from detecting of any stereoscopy, monoscopy or of any particular stereoscopic format on such a frame. In particular, the stereoscopy detector 1002 detects when a frame is substantially black and delays any detection until the received frames of the decompressed frame sequence 109 are no longer black. Black frames may occur in frame sequences as a result of errors or scene changes, among other reasons. Since these frames do not carry any useful visual information, it would be inappropriate to detect stereoscopy of any kind or monoscopy on the basis of a black frame. Thus, when the stereoscopy detector 1002 detects a black frame, it does not perform a detection. The stereoscopy detector 1002 may detect black frames in the decompressed frame sequence 109 by any suitable means, such as by taking an average luminance value of the pixels in the frame and detecting a low average value.

Moreover, while testing for stereoscopy according to any particular encoding format, the stereoscopy detector 1002 may also detect a substantially black portion from amongst the first and second portion selected to be compared, and may, in case of such detection, choose not to perform a detection on the basis of the portions selected but to select new portions and/or wait for a later frame to select the portions from. This is to account for the possibility that a blank frame has been inserted into a left or right image sequence from which a stereoscopic single frame sequence has been encoded or a blank subframe has been created during encoding.

The stereoscopy detector 1002 detects monoscopy as well as stereoscopy. In particular, the stereoscopy detector 1002 is configured to detect whether the decompressed frame sequence is a monoscopic frame sequence. The stereoscopy detector 1002 may perform tests, whereby it inspects the decompressed frame sequence 109 to identify whether it comprises non-stereoscopic frames. However in the present example, the stereoscopic detector 1002 detects monoscopy merely by failing to detect stereoscopy. In particular, the stereoscopy detector 1002 is configured to detect stereoscopy according to any encoding format that the decompressed frame sequence 109 may be expected to be encoded in. Thus, if none of the tests for stereoscopy determine that the decompressed frame sequence 109 is stereoscopic, it is a reasonable conclusion that the decompressed frame sequence 109 is monoscopic. Thus the stereoscopy detector 1002 detects stereoscopy on this basis.

It should be noted that the stereoscopy detector may detect monoscopy by the failure of stereoscopic detection tests to detect stereoscopy regardless of how many different stereoscopic encoding format detection tests are supported. For example, if the decompressed frame sequence 109 is only expected to be either side-by-side or monoscopic, a single test might be implemented by the stereoscopy detector 1002: a stereoscopy detection test according to the side-by-side format. If the stereoscopy detector 1002 detects stereoscopy, the decompressed frame sequence 109 is known to be in the side-by-side encoding format, otherwise it is known to be monoscopic.

As mentioned above, the stereoscopy detector 1002 is configured to test for stereoscopy according to several different encoding formats. The stereoscopy detector uses the results of the different tests to not only detect stereoscopy but also to determine an encoding format for the decompressed frame sequence 109. The determined format determined by the stereoscopy detector 1002 is a format according to which the decompressed frame sequence may be decoded. It may also be the format according to which it is believed that the decompressed frame sequence was encoded.

Assuming now that the decompressed frame sequence 109 is a stereoscopic single frame sequence, the stereoscopy detector 1002 may determine the format of the decompressed frame sequence 109 in a number of ways.

In a first example, the stereoscopy detector 1002 is configured to test for stereoscopy according to different encoding formats in sequence. As the stereoscopy detector 1002 runs through the different tests (each of which returns a detected/not-detected Boolean, it stops as soon as a particular test detects stereoscopy). The format is then detected as being that for which the test was testing. For example, the stereoscopy detector may be configured to test for stereoscopy according first to above-below, then to side-by-side and then to tile encodings formats. Note that in such a sequential environment, the stereoscopy module 1002 may have to use different frame for each test (particularly if the processing power of the integrated system 106 does not permit more than one test to be performed within the time frame in which a particular frame is received), or (if several tests can be run within the time interval of a particular frame) it may run several (or all) tests on using same frame(s).

Returning to the sequential example of format detection, assume that the decompressed frame sequence 109 is encoded in side-by-side format, the stereoscopy module 1002 would first attempt to detect stereoscopy according to an above-below format in a first test, which has been described above. The result would be a negative detection. The stereoscopy module 1002 would then attempt to detect stereoscopy according to a side-by-side encoding format, in the manner described above, and the result would be a positive detection. The stereoscopy module would then cease to test for stereoscopy and output an output over connection 1003 indicative of the detection. Since the decoded format is side-by-side, it is followed by quincunx detection by the quincunx detector 1402. Following the side-by-side detection, the stereoscopy detector may cease stereoscopy detection (e.g. if it is configured to run once, at a beginning of a frame sequence) or it may continue to perform sequential detections in case the format should change or the decompressed frame sequence should become no longer stereoscopic.

In a second example, the stereoscopy detector 1002 may perform stereoscopy detection according to several different encoding formats in parallel. In this example, the manner of detecting stereoscopy may be the same as above, however a contention-resolution mechanism is in place, in case more than one different test returns a detection (which should not happen, in an error-free context). For example, the tests may simply be prioritized (e.g. in order of industry adoption of their respective encoding formats) and if two tests return a detection, the stereoscopy detector 1002 detects the format of whichever one has the highest priority.

In yet another example, the stereoscopy detector 1002 is configured to detect stereoscopy according to several different encoding formats using the tests described above, with the tests being defined so as to return as a result not a Boolean value but a level of confidence of the detection for each of their respective formats. In this example, the stereoscopy detects an encoding format of the decompressed frame sequence 109 based on the test which detects stereoscopy with the highest level of confidence. There is also a contention-resolution mechanism in case the two highest tests have the same level of confidence. Moreover, the stereoscopy detector 1002 applies a minimum threshold of confidence to detect stereoscopy. If no test returns a result above the minimum threshold of confidence, it is determined that the decompressed frame sequence 109 is not stereoscopic.

Once the stereoscopy detector 1002 has detected stereoscopy according to a particular encoding format, the stereoscopy detector 1002 then outputs over connection 1003 an indication that stereoscopy has been detected and, optionally, a level of confidence associated with the detection. If the stereoscopy detector can detect a particular format of the decompressed frame sequence 109, as in the examples above, it may also output an indication of the format detected and, optionally, a level of confidence associated with the detection.

It is to be understood that the stereoscopy detector 1002 may detect stereoscopy with a single comparison of two portions as described above. Thus advantageously, the stereoscopy detector 1002 may behave extremely rapidly, and quicker than a human eye can perceive. In particular, true merged frame stereoscopic formats may be detected within a single frame and frame sequential and non-true formats may be detected within as few as two frames. In both true merged frame formats and non-true merged frame or frame sequential formats, the computational requirements are very low thanks to the need for as little as a single comparison between portions.

It is to be understood that the stereoscopy detector 1002 may run continuously in the integrated system 106 so at to be able to detect a change between stereoscopy and monoscopy or between different stereoscopic formats in the decompressed frame sequence 109. In particular, the decompressed frame sequence 109 may be in one of a plurality of modes. A mode may be one of a stereoscopic or monoscopic mode, or a mode may be one of a monoscopic or a plurality of stereoscopic modes according to different stereoscopic encoding formats. A change in the mode of the decompressed frame sequence 109 may be detected by the stereoscopy detector 1002. Upon detecting such a change, the stereoscopy detector 1002 communicates with the stereoscopic decoder 1004 and causes it to change the stereoscopic decoding accordingly. However, if short detection errors occur, rapid switching between stereoscopy and monoscopy or between different stereoscopic encoding formats may cause improper decoding switching, with undesirable visual consequences. Accordingly, the stereoscopic detector 1002 may perform stereoscopy testing over a certain period of time. For example the stereoscopic detector 1002 may be configured to detect a change in the mode of the decompressed frame sequence 109, such as a change between stereoscopy and monoscopy or between different stereoscopic formats, of the only after the change has been observed for a certain amount of time. To this end, the stereoscopy detector 1002 may implement a deliberate hysteresis to delay detecting a change between modes, until a certain level of confidence has been achieved.

To this end, the stereoscopy detector 1002 may perform stereoscopy testing over a period of time. The stereoscopy detector 1002 may thus ensure that a change is observed by the stereoscopic detector 1002 for at least a certain period of time prior detecting the change. To this end, the stereoscopic detector 1002 may detect a change between stereoscopy and monoscopy or between different stereoscopic formats based on more than one instance of a stereoscopic detection test, such as the tests described above, at more than one point in time. In particular, the stereoscopy detector 1002 may not detect a change between stereoscopy and monoscopy or between different stereoscopic formats until a certain level of confidence in the change has been achieved.

In a first non-limiting example of deliberate hysteresis, if a test indicates that a change between stereoscopy and monoscopy or between different stereoscopic formats has occurred, the stereoscopy detector 1002 still does not determine that a change between stereoscopy and monoscopy or between different stereoscopic formats has occurred until several instances of the test corroborate the detected change. Any number of corroborating tests may be required to determine that a change has occurred and in a non-limiting example, the stereoscopy detector 1002 only changes between stereoscopy and monoscopy or between different stereoscopic formats if 10 different instances of a test indicate the same between stereoscopy and monoscopy or between different stereoscopic formats.

In this example, however, if a genuine change between stereoscopy and monoscopy or between different stereoscopic formats occurs, any error in the first 10 tests will result in a delayed detection of the change. If each test occurs on sequential frames, and the error occurs on the 10^{th} frame, it may take as many as 20 frames (or more, if additional errors occur) to detect a change. These delays may be undesirably visible to the user.

In a second non-limiting example of hysteresis, the stereoscopy detector 1002 maintains a count of the number of tests indicating a particular change between stereoscopy and monoscopy or between different stereoscopic formats. When the stereoscopy detector 1002 first detects a change between stereoscopy and monoscopy or between different stereoscopic formats, it starts the count at 1. It then increments the count at every subsequent test that corroborates the detected change between stereoscopy and monoscopy or between different stereoscopic formats. However, for every subsequent test that does not corroborate the change, it decrements the count. Once the count reaches a predetermined value, for example 10, it determines that the repeatedly detected change has indeed occurred and it generates an output accordingly, which output may, for example, instruct the stereoscopic decoder 1004 to change decoding modes accordingly.

In this example, if a change between stereoscopy and monoscopy or between different stereoscopic formats does occur but a detection error occurs as well during the first few tests, the detection error only delays detection of a change by one test instance.

If several formats are detectable by the stereoscopy detector 1002, there might be a different count for each format. Alternatively, there might be a single count that can only designate a new format when it is at zero. Alternatively still, there can be a primary count, which counts causes a detection of a change when it reaches, e.g. 10, and secondary counts which count the number of times the detection of a second change has decremented the primary count. Detections that increment the primary count decrement the secondary counts. When a secondary count becomes higher than the primary count, it becomes the primary count and when it reaches 10, it causes a detection of the second change.

In a third example of deliberate hysteresis, the stereoscopy detector 1002 takes into account the level of confidence of a detection indicating a change between stereoscopy and monoscopy or between different stereoscopic formats. In this example, the stereoscopy test(s) provide a level of confidence that a stereoscopy, or stereoscopy according to a particular format, has been detected. The stereoscopy detector 1002 uses this information in determining whether a change between stereoscopy and monoscopy or between different stereoscopic formats has occurred. In this example, the stereoscopy detector 1002 maintains a count as in the previous example, but the stereoscopy detector 1002 increments the count in an amount proportional to the level of confidence of the detection indicating a change. In addition, the stereoscopy detector 1002 does not take into account any detection below a certain threshold. In this example, the level of confidence is given as a percentage, and only levels of confidence about 60% result in an incrementing of the count. For levels of confidence above 60% every percentage point is counted as one point towards the count. If a first test detecting a change between stereoscopy and monoscopy or between different stereoscopic formats indicates a 72% level of confidence in the particular change detected, the count starts at 72. Moreover, when a test indicates a detection of a different change by a certain confidence level (also above a certain threshold), the level of confidence of this second change may decrement the count. In this example, the weight of the decrement is the number of percentage points of the confidence level of the detection of the second change, although it could also be weighed differently. In this example, every different possible change to a different mode has an associated count, although there could be only one count (which changes mode designation when it reaches, e.g. zero) or a primary and secondary counts as in the previous example as well.

Any other manner of creating deliberate hysteresis may be used and it will be appreciated that the ones described above, and the thresholds provided are exemplary only. In other embodiments, more complex mechanisms may be used to take into account more than one instance of a test or more than one test in the detection of a change between stereoscopy and monoscopy or between different stereoscopic formats. For example, the stereoscopy detector 1002 may implement any manner of delayed-response model or a model emulating a proportional/Derivative/Integral (P.I.D.) controller.

As has been described above, the stereoscopic decoder 1004 may decode the decompressed frame sequence 109 according to a detected stereoscopy/non-stereoscopy mode. Advantageously, the system described allows proper processing (e.g. for displaying on a TV screen) of an incoming frame sequence which might be in one or more different stereoscopic formats or monoscopic without any user input.

If the stereoscopy detector 1002 decodes stereoscopy, it informs the stereoscopic decoder 1004 over connection 1003. If several different stereoscopic formats are supported, the stereoscopy detector 1002 further informs the stereoscopic decoder 1004 of the stereoscopic format of the decompressed frame sequence 109. The stereoscopic decoder 1004 decodes the decompressed frame sequence 109 according to a particular stereoscopic encoding (decoding) scheme to produce a dual decoded frame sequence 111 comprising a left decoded frame sequence recovered from the decompressed frame sequence (e.g. from left subframes) and a right decoded frame sequence recovered from the decompressed frame sequence (e.g. from right subframes). Of course, if the stereoscopy detector 1002 determines that the decompressed frame sequence 109 is not stereoscopic, the output the stereoscopic decoder 1004 does not perform stereoscopic decoding and its output is a monoscopic single frame sequence instead of the dual decoded frame sequence 111.

The dual decoded frame sequence 111 may then optionally undergo a variety of operations by a variety of modules. In the particular embodiment shown, the architecture 100 is generally a television architecture. In this context, an interlacing module 112 performs deinterlacing as needed. A scaling module 114 may then be used to scale frames according to the actual display of the television. An optional image enhancer 116 may provide any of a number of image enhancement functions including deblurring, noise reduction, edge enhancement, and all manner of filters. Of course, the various function of the image enhancer 116 may alternatively be split amongst different modules. A color module 118 may perform any required color conversion or color enhancement and a compositing module 120 may take care of any compositing required, for example for on-screen menu displays.

In this example, each of these modules operate on a dual frame sequence (as decoded by the stereoscopic decoder 1004) if the input signal is stereoscopic. Optionally, each module may be made aware of whether stereoscopy has been detected/decoded, by any suitable mean (not shown) by, e.g. the stereoscopy detector 1002 or the stereoscopic decoder 1004.

Finally, at the output of the integrated system 106 is provided an output interface 122 which generates the display driving signal. The output interface 122 may, for example, generate an LVDS signal to drive a panel display. If the input signal is stereoscopic (and therefore the output interface 122 receives a dual frame sequence), another role of the output interface is to format a dual frame sequence into a format useable by the display for displaying stereoscopy. Although this formatting function is performed in this example by the output interface 122, it may alternatively be performed by a separate formatting module in the integrated system 106. It will also be appreciated that the output interface 122 itself may be in the integrated system 106, as could the input interface 104.

It is to be understood that all modules are provided here for illustrative purposes only. Modules shown in FIG. 10 can be omitted or altered. The particular order and organisation of the modules shown in FIG. 10 is exemplary only and serves merely for illustrative purposes.

The stereoscopy detector 1002 and the stereoscopic decoder 1004 could be separate modules in the integrated system. The stereoscopy detector 1002 and stereoscopic decoder 1004 could be located elsewhere along the line, not necessarily adjacent one another. In particular, the stereoscopy module and its components could be organized differently.

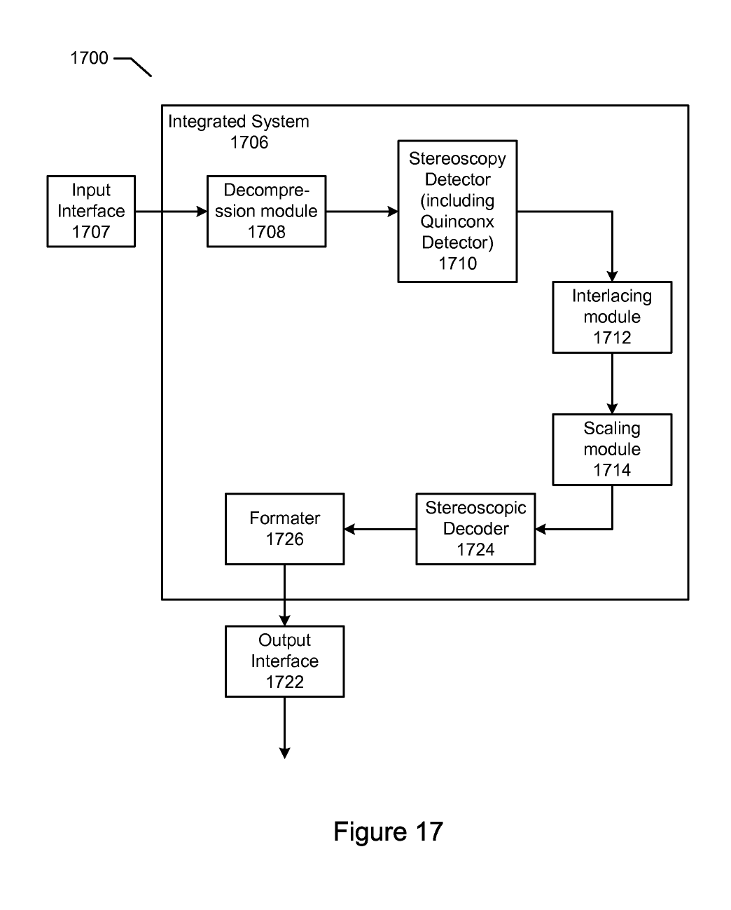

FIG. 17 shows an example of an alternate arrangement of modules according to an architecture 1700. For simplicity, several modules have been omitted; in this example, an input compressed frame sequence 1705 undergoes decompression, scaling, interlacing, and stereoscopic decoding and formatting. As shown, an input signal 1702 is received by an input interface 1704 as I the example of FIG. 10. Also as in that example, the input interface recovers a compressed frame sequence 1705 from the input signal 102 and provides it to a decompression module 1708 which decompresses it to derive a decompressed frame sequence 1709. The decompressed frame sequence is then provided to a stereoscopy detector 1710, which detects whether the decompressed frame sequence 1709 is a stereoscopic frame sequence. In this example, the stereoscopy detector 1710 also performs quincunx detection to determine if a stereoscopic frame sequence is quincunx-encoded. In this example, the decompressed frame sequence 1709 is then provided to an interlacing module 1712 which performs de-interlacing if needed, and to a scaling module 1714, which scales as needed. Downstream of these two modules is located the stereoscopic decoder 1724, which receives information on whether the decompressed frame sequence 1709 is stereoscopic and in which stereoscopic format, if any, the decompressed frame sequence 1709 is encoded from the stereoscopy detector 1710 (communication between modules not shown). Based on the information received from the stereoscopy detector 1710, the stereoscopic decoder 1724 performs a decoding operation to recover decoded left and right frames in a decoded dual frame sequence and provides these to a formatter 1726 that formats the decoded dual frame sequence according to display requirements. The formatted data is sent to the output interface 1722 which then generates an output with which to drive the display.

In the above example, the scaling and deinterlacing operations are done on the decompressed frame sequence 1709, which advantageously is a single frame sequence. This avoids the need for a dual pipeline. However, while traditional scaling and deinterlacing methods may work will with stereoscopic single frame sequence encoded according to certain encoding formats, these operations may not work, or work sub-optimally with other encoding formats. To this end, the interlacing module 1712 and the scaling module 1714 may be adapted to function differently based on the stereoscopic encoding format, if any, of the decompressed frame sequence 1709. For example, the scaling module 1714 may apply a different scaling method to quincunx side-by-side encoded merged frame so as to account for the quincunx decimation pattern undergone by the merged frame. Likewise, the interlacing module 1712 may perform a different deinterlacing for quincunx side-by-side encoded merged frames, in order to preserve the quincunx pattern undergone by the merged frame. Other modules not shown here may also use knowledge of the stereoscopic or non-stereoscopic nature of the decompressed frame sequence 1709 in their operations. To these ends, the stereoscopy detector 1710 may communicate with other modules (not shown in FIG. 17), or the information derived by it may be accessed by some other manner by the various modules in the integrated system 1706.

The stereoscopic decoder 1724 may also take into account known effects of scaling and interlacing and (and other functions performed by other modules, if present) in decode the frame sequence accordingly. For example, the stereoscopic decoder 1724 may use knowledge of a scaling operation to identify particular pixels that are original pixels, that have not been or minimally been affected by the scaling, and rely more (or only) on these to reconstruct decoded left and right frames.

It is to be understood that the television context which has been used for the purposes of this description has been used for illustrative purposes. The stereoscopy detection and image processing described herein may be used in a number of different contexts as well. For example, stereoscopy detection as described herein may be used in the context of professional and broadcast equipment wherein image processing must be adapted to the particular format of a frame sequence. In another example of applicability, stereoscopy detection is useful in set-top boxes.

In a particular embodiment, the stereoscopy module 110 is implemented in a set-top box. The set-top box receives a plurality of single frame sequences and identifies whether these are monoscopic or stereoscopic single frame sequences, and in the latter case, which stereoscopic encoding format corresponds to the received frame sequences. The stereoscopy module performs stereoscopic decoding on the stereoscopic single frame sequences received a places them in a format acceptable for transmission to the connected television. In particular, the set-top box has an HDMI 1.4a connection to the television and transmits stereoscopic streams to the television in either frame-packing or a particular merged frame format suited for the television. Moreover, the set-top box may be adapted to detect stereoscopic dual frame sequences received at the set-top box over two channels as described above. To this end, the set-top box performs detection of stereoscopic dual frame sequences by doing portion comparison over different input channels into the set-top box. By performing such testing over all the different input channels into the set-top box, the set-top box may thus receive a stereoscopic dual frame sequence over any two monoscopic channels and detect it as a stereoscopic frame sequence without any special instructions being provided to the set-top box.

In the above example, the set-top box is adapted to detect whether a connected television is capable of supporting stereoscopic image streams and/or in which format the television can receive stereoscopic image streams. The set-top box may have this information input by a user using appropriate input means (e.g. remote control), it may be pre-programmed to know the television's capabilities or, more conveniently, it may discover this information using signalling between itself and the television, such as signalling afforded by the HDMI 1.4a protocol. The stereoscopy module within the set-top box may use this information to determine what to do with a received frame sequence. In particular if the received frame sequence is stereoscopic, the stereoscopy module 1002 will detect it as such and inform the stereoscopic decoder 1004. The stereoscopic decoder 1004, in turn, will determine the capabilities of the television and decode the stereoscopic frame sequence into a format acceptable to the television. For example, if the television does not support stereoscopy, the stereoscopic decoder 1004 may recover the left (or right) frames from the stereoscopic frame sequence and provide only these to the television. Alternatively, if the television supports stereoscopy but requires stereoscopic image streams to be provided to it in frame-packing format, the stereoscopic decoder 1004 may provide it in such format or may provide it to another module (e.g. output interface) in such a manner as to allow that other module to provide it to the television in such a format.

Although providing flexibility for different format supports has been described in the context of a set-top box above, it is to be understood that his may be provided in other contexts as well. In the context of the integrated system 106 described above, this integrated system may be used for several models of televisions including certain ones with non-stereoscopic displays. In such cases, knowledge of the display's supported format (e.g. pre-programmed, detected at the output interface, or input by a user using an appropriate interface) may be used by the stereoscopic decoder 1004 or the output interface 122 (or any other module) to format the output into a format suitable for the display. Other contexts where this might be useful is in professional and broadcast equipment, which may be used with other equipment that may or may not support stereoscopy.

Thus it will be appreciated that the techniques described above may be implemented in any image processing apparatus adapted to receive an image stream. In particular a television, set-top box, or other image processing apparatus that can receive an image stream may implement a stereoscopy detector 1002 as described above. This is particularly useful if the image processing apparatus may receive an image stream in a particular mode from a plurality of modes, where the plurality of modes comprises a monoscopic mode, and a plurality of stereoscopic modes. In the monoscopic mode, the image stream may be in the form of a monoscopic single frame sequence. However, there is a plurality of stereoscopic modes, corresponding to different manners of providing stereoscopic image streams, such as with different stereoscopic encodings. Using the stereoscopy detector 1002 or stereoscopic detection techniques described herein, the image processing apparatus may then detect the particular mode of the image stream and process it accordingly. For example it may decode the image stream according to an appropriate stereoscopic encoding format if the particular mode is a stereoscopic mode.

If the image processing apparatus is connected to a display device, it may then use known techniques to cause the display device to display the image stream monoscopically or stereoscopically. For example, if the image processing apparatus is the architecture 100, it may be used to cause a television display panel to display the image stream. If the image processing apparatus is a set-top box, it may cause a television display device to display the image stream monoscopically or stereoscopically by providing the image stream either monoscopically or stereoscopically, or stereoscopically and/or instructions on how to display the image stream to a television.

The choice of whether to cause the display device to display monoscopically or stereoscopically may be based purely on the mode of the image stream (e.g. if stereoscopic, display stereoscopically, if monoscopic, display monoscopically), or it may be based on other factors as well. For example, if the image stream is in a monoscopic mode, it will be displayed necessarily monoscopically but if it is in a stereoscopic mode, the image processing apparatus may weigh other factors in deciding whether to cause the display device to display it stereoscopically or monoscopically (e.g. by providing it with only a left image stream or a right image stream). These factors may include knowledge of a user-selected monoscopic or stereoscopic mode, or knowledge of the capability/incapability of the display device to display stereoscopically.

It is to be understood that any decoding methods may be used by the stereoscopic decoder. For example if the decompressed frame sequence 109 is in a quincunx side-by-side merged frame format, the stereoscopic decoder 1004 de-multiplexes the frame in order to extract therefrom sampled frames F₀ and F₁. Once the frame has been separated out into frames F₀ and F₁, each frame is horizontally inflated (i.e. de-collapsed) to reveal the missing pixels, that is the pixels that were decimated from the original frames at the source. The stereoscopic decoder 1004 is then operative to reconstruct each frame F₀, F₁, by spatially interpolating each missing pixel at least in part on a basis of the original pixels surrounding the respective missing pixel. Upon completion of the spatial interpolation process, each reconstructed frame F₀, F₁ will contain half original pixels and half interpolated pixels.

Note that various different interpolation methods are possible and can be implemented by the stereoscopic decoder 1004 in order to reconstruct the missing pixels of the frames F₀, F₁, without departing from the scope of the present invention. In a specific, non-limiting example, the pixel interpolation method relies on the fact that the value of a missing pixel is related to the value of original neighbouring pixels. The values of original neighbouring pixels can therefore be used in order to reconstruct missing pixel values. In commonly assigned U.S. Pat. No. 7,693,221 issued Apr. 6, 2010, the specification of which is hereby incorporated by reference, several methods and algorithms are disclosed for reconstructing the value of a missing pixel, including for example the use of a weighting of a horizontal component (HC) and a weighting of a vertical component (VC) collected from neighbouring pixels, as well as the use of weighting coefficients based on a horizontal edge sensitivity parameter.

The present invention is directed to a method and system for detecting compressed stereoscopic image frames in a digital video stream, whereby the receiving end of a digital video transmission is capable to support a stereoscopic broadcasting service in addition to the more common monoscopic formats.

In one embodiment, there is provided a method for detecting compressed stereoscopic image frames in a digital video stream. The method includes, for each frame of a received video stream, determining if a match exists between the pixels of one half of the frame and the pixels of the other half of the frame for each one of at least a subset of lines of the frame. If such a match is found for at least a majority of the lines of the frame, it is determined that the frame is a compressed stereoscopic frame, otherwise it is determined that the frame is a non-stereoscopic frame. An output signal indicative of the determined result is then generated.

Advantageously, techniques described herein for identifying a stereoscopic broadcasting service at the receiving end of a transmission channel are completely transparent to the operations at the transmitting end. Furthermore, a very simple and relatively inexpensive software installation or upgrade is all that is required to enable a processing unit at the receiving end to implement the frame detection operations of the present invention, thereby rendering the receiving end capable to support both stereoscopic and non-stereoscopic broadcasting services.

Although the examples provided here have been provided mainly in the context of displaying a received frame sequence, it is to be understood that the technologies described herein may be used in the context of storing or (re)broadcasting a frame sequence according to a particular format.

The various components and modules of the architecture 100 may all be implemented in software, hardware, firmware or any combination thereof, within one piece of equipment or distributed among various different pieces of equipment. The stereoscopy module 110 or any part thereof (e.g. the stereoscopy detector 1002) may be built into one or more processing units of existing receiver systems, or more specifically of existing decoding systems. Existing decoding systems may be provided with the capacity to perform the frame detection operations described herein by a dedicated processing unit or firmware update. In the course of computing and comparing the characteristic pixel parameters of the frames of the compressed image stream, the respective processing unit(s) may temporarily store pixels and/or computed pixel parameter values in a memory, either local to the processing unit or remote (e.g. a host memory via bus system). It should be noted that storage and retrieval of frame lines or pixels may be done in more than one way. Obviously, various different software, hardware and/or firmware based implementations of the techniques of the described embodiments also.

Although various embodiments have been illustrated, this was for the purpose of describing, but not limiting, the present invention. Various possible modifications and different configurations will become apparent to those skilled in the art and are within the scope of the present invention, which is defined more particularly by the attached claims.

What is claimed is:

1. A method of detecting stereoscopy in a digital image stream comprising
a frame sequence, the method comprising:
a. receiving at an input the frame sequence;
b. detecting whether the frame sequence is in one of a plurality of stereoscopic encoding formats; and
c. outputting at an output an indication of the result of the detecting.

2. The method of claim 1, wherein the detecting comprises if the frame sequence is in one of the plurality of stereoscopic encoding formats, identifying which particular encoding format of the plurality of stereoscopic encoding formats the frame sequence is in.

3. The method of claim 2, wherein the outputting comprises outputting an indication of the particular encoding format.

4. The method of claim 2, further comprising decoding the frame sequence according to the particular encoding format to generate a decoded stereoscopic dual frame sequence comprising a decoded left frame sequence and a decoded right frame sequence.

5. The method of claim 4, wherein the indication of the result of the detecting is the stereoscopic dual frame sequence.

6. The method of claim 1, wherein the plurality of stereoscopic encoding formats comprises side-by-side and above-below.

7. The method of claim 6, wherein the plurality of stereoscopic encoding format further comprises line-interleave and column-interleave.

8. The method of claim 2, wherein the plurality of stereoscopic encoding format comprises side-by-side, wherein if the frame sequence is in side-by-side format identifying which particular encoding format of the plurality of stereoscopic encoding formats the frame sequence is in further comprises identifying whether the frame sequence is in quincunx side-by-side format.

9. The method of claim 1, wherein the detecting comprises performing at least one of a plurality of stereoscopy tests, each of the plurality of stereoscopy tests determining whether the frame sequence is stereoscopic according to a corresponding one of the plurality of stereoscopic encoding formats.

10. The method of claim 9, wherein each of the plurality of stereoscopy tests determines whether the frame sequence is in its corresponding stereoscopic encoding formats.

11. The method of claim 1, wherein the detecting comprises performing stereoscopy testing over a period of time.

12. The method of claim 11, wherein the performing stereoscopy testing over a period of time comprises observing stereoscopy according to the particular stereoscopic encoding format at plural distinct frame times over the period of time.

13. The method of claim 12, wherein the performing stereoscopy testing over a period of time comprises performing a stereoscopy test several times over different portions of the frame sequence to determine a plurality of test results and detecting that the frame sequence is in a stereoscopic encoding format only if a plurality of the test results indicate stereoscopy.

14. The method of claim 1, wherein the detecting comprises selecting in the frame sequence a first test portion and a second test portion, and performing a portion comparison to determine whether the first and second test portions have a certain degree of similarity.

15. The method of claim 14, wherein performing a portion comparison comprises identifying a plurality of segments in the first portion and a plurality of respectively corresponding segments in the second portion and for each a segment in the first portion, performing a segment comparison with the corresponding segment in the second portion.

16. The method of claim 1, wherein the frame sequence is a single frame sequence.

17. A system for detecting stereoscopy comprising:
a. an input for receiving a frame sequence;
b. a stereoscopy detector for in communication with the input configured to detect on the basis of at least a portion of the frame sequence whether the frame sequence is in one of a plurality of stereoscopic encoding format; and
c. an output in communication with the stereoscopy detector for outputting an indication of the result of the detecting.

18. The system of claim 17, wherein the stereoscopic detector is configured to identify if the frame sequence is in one of the plurality of stereoscopic encoding formats which particular encoding format of the plurality of stereoscopic encoding formats the frame sequence is in.

19. The system of claim 18, wherein the output is adapted to output an indication of the particular encoding format in the indication of the result of the detecting.

20. The system of claim 18, further comprising a stereoscopic decoder for decoding the frame sequence according to the particular encoding format to generate a decoded stereoscopic dual frame sequence comprising a decoded left frame sequence and a decoded right frame sequence.

21. The system of claim 20, wherein the output is configured to output the stereoscopic dual frame sequence as at least a portion of the result of the detecting.

22. The system of claim 17, wherein the plurality of stereoscopic encoding formats comprises side-by-side and above-below.

23. The system of claim 22, wherein the plurality of stereoscopic encoding formats further comprises line-interleave and column-interleave.

24. The system of claim 17, further comprising a quincunx detector for detecting if a side-by-side frame sequence is a quincunx side-by-side frame sequence.

25. The system of claim 17, wherein the stereoscopy detector is configured to perform a plurality of stereoscopy tests, each of the plurality of stereoscopy tests being adapted to detect stereoscopy according to a respective corresponding stereoscopic encoding format, the stereoscopy detector detecting whether the frame sequence is in one of a plurality of stereoscopic encoding formats by performing at least one of the plurality of stereoscopy tests.

26. The system of claim 25, wherein the stereoscopy detector is adapted to determine on the basis of each stereoscopy test result whether the frame sequence is in the corresponding format.

27. The system of claim 17, wherein the frame sequence is in one of a plurality of modes, the stereoscopy detector is configured to detect a change over time in the mode of the frame sequence, the plurality of modes comprising a stereoscopic mode and a monoscopic mode.

28. The system of claim 27, wherein the plurality of modes comprises a different stereoscopic mode for each of the plurality of stereoscopic encoding formats.

29. The system of claim 27, wherein the stereoscopy detector is configured to detect a change in the mode only after the change has been observed for a certain amount of time.

30. The system of claim 29, wherein the stereoscopy detector performs a stereoscopy test several times over different portions of the frame sequence to determine a plurality of test results, the stereoscopy detector detecting a change in the mode of the frame sequence only if a plurality of the test results indicate the change of mode.

31. The system of claim 17, wherein the stereoscopy detector is configured to select a first test portion and a second test portion of the frame sequence and to perform a portion comparison, wherein the stereoscopy detector detects stereoscopy based on the result of the portion comparison.

32. The system of claim 31, wherein the portion comparison comprises identifying a plurality of segments in the first portion and a plurality of respectively corresponding segments in the second portion and for each a segment in the first portion, performing a segment comparison with the corresponding segment in the second portion.

33. An image processing apparatus in connection with a display device, the image processing apparatus being configured to:
a. receive an image stream in a particular mode from among a plurality of modes, the plurality of modes comprising a monoscopic mode and a plurality of stereoscopic modes;
b. detect the particular mode; and
c. cause the display device to display the image stream either monoscopically or stereoscopically at least in part on the basis of the mode detected.

34. The image processing apparatus of claim 33, wherein the image processing apparatus is further configured to cause the display device to display the image stream either monoscopically or stereoscopically further in part on the basis of a user selection of monoscopy or stereoscopy.

35. The image processing apparatus of claim 33, wherein the image processing apparatus is a television controller.

36. The image processing apparatus of claim 33, wherein the image processing apparatus is a set-top-box.
